(19) United States
(12) Patent Application Publication
(10) Pub. No.: US 2009/0185828 A1
(43) Pub. Date: Jul. 23, 2009

(54) Lens Array, Exposure Head, and Image Forming Apparatus

(75) Inventors: Ryuta KOIZUMI, Shiojiri-shi (JP); Yujiro NOMURA, Shiojiri-shi (JP); Takeshi SOWA, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/354,579

(22) Filed: Jan. 15, 2009

(30) Foreign Application Priority Data
Jan. 18, 2008 (JP) 2008-009205
Dec. 18, 2008 (JP) 2008-321936

(51) Int. Cl. G03G 15/04; G02B 27/12

(52) U.S. Cl. 399/218; 359/619; 399/221

(57) ABSTRACT

A lens array includes a light-transmissive substrate that satisfies the condition W1>W2, where W1 is the length of the light-transmissive substrate in a first direction and W2 is the length of the light-transmissive substrate in a second direction perpendicular to the first direction, a first lens that is provided on the light-transmissive substrate, and a second lens that is provided on the light-transmissive substrate on the second direction side of the first lens. The first lens and the second lens are connected to each other.

### CROSS-REFERENCE TO RELATED APPLICATIONS

This application claims the benefit of priority under 35 USC 119 of Japanese patent application no. 2008-009205, filed on Jan. 18, 2008, and Japanese patent application no. 2008-321936, filed on December 18, 2008, which are incorporated herein by reference.

### BACKGROUND

1. Technical Field

The present invention relates to a lens array in which a plurality of lenses are arranged, an exposure head using the lens array, and an image forming apparatus.

2. Related Art

A lens array, for example, described in JP-A-6-278314 (FIG. 2) is known in which a plurality of lenses are arranged. In this lens array, each lens images incident light. A latent image carrier, such as a photoconductor drum, is exposed to light imaged by each lens, and a latent image is formed.

In order to cope with exposure with higher resolution, a lens array may be formed by arranging a plurality of lenses in a two-dimensional manner. That is, in this lens array, a plurality of lenses are arranged at different positions in a lateral direction (second direction) perpendicular or substantially perpendicular to a longitudinal direction to form a lens column, and a plurality of lens columns are arranged in the longitudinal direction.

In terms of preferable exposure, it is preferable to increase the amount of light incident on the lens. To this end, for example, it is considered to increase the diameter of the lens. However, in a lens array in which a plurality of lenses are arranged in a two-dimensional manner, in order to increase the diameter of the lens, it is necessary to increase a lens pitch in the lateral direction in the lens column. As a result, the width of the lens array (that is, the length in the lateral direction) increases, and the lens array increases in size.

### SUMMARY

An advantage of some aspects of the invention is that it provides a lens array that can cope with exposure with high resolution and can be reduced in size, an exposure head using the lens array, and an image forming apparatus.

According to a first aspect of the invention, a lens array includes a light-transmissive substrate that satisfies the condition W1>W2, where W1 is the length of the light-transmissive substrate in a first direction and W2 is the length of the light-transmissive substrate in a second direction perpendicular to the first direction, a first lens that is provided on the light-transmissive substrate, and a second lens that is provided on the light-transmissive substrate on the second direction side of the first lens. The first lens and the second lens are connected to each other.

In this aspect (the lens array) of the invention having the above-described configuration, the first lens and the second lens are provided on the light-transmissive substrate. The light-transmissive substrate satisfies the condition W1>W2, where W1 is the length of the light-transmissive substrate in the first direction and W2 is the length of the light-transmissive substrate in the second direction perpendicular or substantially perpendicular to the first direction. That is, the light-transmissive substrate is long in the first direction. The second lens is provided on the second direction side of the first lens. In other words, the first lens and the second lens are provided at different positions in the second direction. In this aspect of the invention, the first lens and the second lens are connected to each other. Therefore, the first lens and the second lens can be adapted to receive a larger amount of light without increasing a clearance between the first lens and the second lens. As a result, the lens array of this aspect can perform an exposure operation by a large light amount without increasing the width of the lens array in the second direction, can cope with exposure with high resolution, and can be reduced in size.

The light-transmissive substrate may be provided with a third lens in the first direction of the first lens, and a clearance may be provided between the first lens and the third lens. As described below, this configuration can prevent the lens array from being deformed due to a change in temperature, and thus ensures a more preferable exposure operation.

The light-transmissive substrate may be a glass member. That is, glass has a comparatively small linear expansion coefficient. Therefore, the configuration in which the light-transmissive substrate is a glass member can prevent the lens array from being deformed due to a change in temperature, and thus ensures a more preferable exposure operation.

The first lens, the second lens, and the third lens may be formed of a resin material. The resin material has a comparatively larger linear expansion coefficient than glass. For this reason, if the temperature changes, the lens array may be deformed due to a difference in linear expansion coefficient between the resin material and glass. Therefore, in the configuration in which the first lens, the second lens, and the third lens are formed of a resin material, a clearance is preferably provided between the first lens and the third lens in order to suppress deformation of the lens array due to a change in temperature.

The resin material may be photocurable resin. The photocurable resin is cured by light irradiation. Therefore, if the lens is formed of photocurable resin, the lens array can be simply manufactured.

According to a second aspect of the invention, an exposure head includes a lens array that has a light-transmissive substrate satisfying the condition W1>W2, where W1 is the length of the light-transmissive substrate in a first direction and W2 is the length of the light-transmissive substrate in a second direction perpendicular to the first direction, a first lens provided on the light-transmissive substrate, and a second lens provided on the light-transmissive substrate on the second direction side of the first lens, and a light emitting element substrate that has a first light emitting element emitting light toward the first lens and a second light emitting element emitting light toward the second lens. The first lens and the second lens are connected to each other.

In this aspect (the exposure head) of the invention having the above-described configuration, the lens array has the first lens and the second lens provided on the light-transmissive substrate. The light-transmissive substrate satisfies the condition W1>W2, where W1 is the length of the light-transmissive substrate in the first direction and W2 is the length of the light-transmissive substrate in the second direction perpendicular to the first direction. That is, the light-transmissive substrate is long in the first direction. The second lens is provided on the second direction side of the first lens In other words, the first lens and the second lens are provided at different positions in the second direction. In this aspect of the invention, the first lens and the second lens are connected to each other. Therefore, the first lens and the second lens can be adapted to receive a larger amount of light without increasing a clearance between the first lens and the second lens. As a result, the lens array of this aspect can perform an exposure operation by a large light amount without increasing the width of the lens array in the second direction, can cope with exposure with high resolution, and can be reduced in size.

In the configuration in which the first lens is connected to the second lens provided on the second direction side of the first lens, the lens can be adapted to receive a large light amount without increasing the clearance between the first lens and the second lens. In other words, the width of the lens array in the second direction can be suppressed. As a result, a region where a light emitting element is disposed to correspond to each lens can also be comparatively reduced in the second direction. For this reason, in the light emitting element substrate on which the light emitting elements are disposed, a space can be allowed on both sides in the second direction. A driving circuit for driving the light emitting element may be provided in the empty space. That is, the light emitting element substrate may be configured such that driving circuits for driving the first light emitting element and the second light emitting element are provided on the second direction sides of the first light emitting element and the second light emitting element.

In this case, the light emitting element substrate may be configured such that a first wiring connecting the first light emitting element and the driving circuit, and a second wiring connecting the second light emitting element and the driving circuit are provided. In this configuration, it is preferable that the driving circuits are provided on the second direction sides of the first light emitting element and the second light emitting element This is because the driving circuits can be disposed so as to be comparatively close to the light emitting elements, and thus the wirings can be reduced in length and driving signals having a small depression due to stray capacitance of the wirings can be supplied to the light emitting elements, thereby performing a preferable exposure operation. The driving circuit may include a TFT.

In the configuration in which an organic EL element is used as the light emitting element, the invention is preferably applied. That, is, when an organic EL element is used as the light emitting element, the light amount of the light emitting element is small, as compared with a case in which an LED or the like is used. In particular, when a bottom emission type organic EL element is used as the light emitting element, the light amount of the light emitting element becomes smaller. Therefore, the invention is preferably applied to such a configuration such that the lens receives a large light amount.

According to a third aspect of the invention, an image forming apparatus includes an exposure head that has a lens array having a light-transmissive substrate satisfying the condition W1>W2, where W1 is the length of the light-transmissive substrate in a first direction and W2 is the length of the light-transmissive substrate in a second direction perpendicular or substantially perpendicular to the first direction, a first lens provided on the light-transmissive substrate, and a second lens provided on the light-transmissive substrate on the second direction side of the first lens, and a light emitting element substrate having a first light emitting element emitting light toward the first lens and a second light emitting element emitting light toward the second lens, and a latent image carrier that images light incident on the first lens from the first light emitting element and images light incident on the second lens from the second light emitting element. The first lens and the second lens are connected to each other.

In this aspect (the image forming apparatus) of the invention having the above-described configuration, the lens array has the first lens and the second lens provided on the light-transmissive substrate. The light-transmissive substrate satisfies the condition W1>W2, where W1 is the length of the light-transmissive substrate in the first direction and W2 is the length of the light-transmissive substrate in the second direction perpendicular or substantially perpendicular to the first direction. That is, the light-transmissive substrate is long in the first direction. The second lens is provided on the second direction side of the first lens. In other words, the first lens and the second lens are provided at different positions in the second direction. In this aspect of the invention, the first lens and the second lens are connected to each other. Therefore, the first lens and the second lens can be adapted to receive a larger amount of light without increasing a clearance between the first lens and the second lens. As a result, the lens array of this aspect can perform an exposure operation by a large light amount without increasing the width of the lens array in the second direction, can cope with exposure with high resolution, and can be reduced in size.

A photoconductor drum may be used as a latent image carrier. In this case, if the imaging position of light having entered and been imaged on the first lens and the imaging position of light having entered and been imaged on the second lens are adjusted in accordance with the shape of the photoconductor drum, as described below, the photoconductor drum 21 can be reduced in diameter, and as a result the image forming apparatus can be reduced in size and preferable exposure can be achieved.

A clearance between the first lens and the second lens in the second direction may be set so as to be smaller than 1/20 of the diameter of the photoconductor drum. With this configuration, lens design can be simplified without considerably changing the shapes of the first lens and the second lens.

The first lens and the second lens may be free-form surface lenses. This is because the free-form surface lens ensures improvement of imaging characteristics of the lenses, thereby achieving more preferable exposure.

According to a fourth aspect of the invention, a lens array includes a light-transmissive lens array substrate, on which a plurality of lens columns each having a plurality of lenses arranged at different positions in a second direction perpendicular or substantially perpendicular to a first direction are arranged in the first direction. In each of the lens columns, adjacent lenses are connected to each other.

According to a fifth aspect of the invention, a line head includes a head substrate on which a plurality of light emitting element groups each having a plurality of light emitting elements are arranged, and a lens array in which a lens is provided on a light-transmissive lens array substrate for each light emitting element group. On the lens array substrate, a plurality of lens columns each having a plurality of lenses arranged at different positions in a second direction perpendicular or substantially perpendicular to a first direction are arranged in the first direction. In each of the lens columns, adjacent lenses are connected to each other.

According to a sixth aspect of the invention, an image forming apparatus includes a line head that has a head substrate, on which a plurality of light emitting element groups each having a plurality of light emitting elements are arranged, and a lens array, in which a lens is provided on a light-transmissive lens array substrate for each light emitting element group, and a latent image carrier that is exposed by the line head and has formed thereon a latent image. On the lens array substrate, a plurality of lens columns each having a plurality of lenses arranged at different positions in a second direction perpendicular or substantially perpendicular to a first direction are arranged in the first direction. In each of the lens columns, adjacent lenses are connected to each other.

In these aspects (the lens array, the line head, and the image forming apparatus) of the invention having the above-described configuration, a plurality of lenses are provided on the light-transmissive lens array substrate, and on the lens array substrate, a plurality of lens columns each having a plurality of lenses arranged at different positions in the second direction perpendicular or substantially perpendicular to the first direction are arranged in the first direction. In each of the lens columns, adjacent lenses are connected to each other. Therefore, the lenses can be adapted to receive a large amount of light without increasing the lens pitch in the lateral direction in each lens column. That is, the lens array of this aspect can cope with exposure with high resolution, is reduced in size, and is preferable.

In the lens array substrate, a clearance may be provided between adjacent lens columns in the first direction. With this configuration, it is possible to suppress occurrence of a trouble due to connection of a plurality of lenses arranged in the first direction, as described below.

The lens array substrate may be formed of glass. Glass has a comparatively small linear expansion coefficient. Therefore, if the lens array substrate is formed of glass, the lens array can be prevented from being deformed due to a change in temperature, and as a result, preferable exposure can be achieved without depending on the temperature.

The lenses may be formed of photocurable resin. The photocurable resin is cured by light irradiation. Therefore, if the lenses are formed of photocurable resin, the lens array can be simply manufactured. As a result, costs for the lens array can be suppressed.

The lenses may be free-form surface lenses. This is because the free-form surface lens ensures improvement of imaging characteristics of the lenses, thereby achieving more preferable exposure.

### BRIEF DESCRIPTION OF THE DRAWINGS

The invention will now be described with reference to the accompanying drawings, wherein like numbers reference like elements.

FIG. 1 is an explanatory view of terms used herein.

FIG. 2 is an explanatory view of terms used herein.

FIG. 3 is a diagram showing an example of an image forming apparatus according to the invention.

FIG. 4 is a diagram showing the electrical configuration of the image forming apparatus of FIG. 3.

FIG. 5 is a perspective view schematically showing a line head according to this embodiment.

FIG. 6 is a partial sectional view of the line head taken along the line A-A of FIG. 5.

FIG. 7 is a diagram showing the configuration of a reverse side surface of a head substrate.

FIG. 8 is a diagram showing the configuration of a light emitting element group provided on the reverse side of the head substrate.

FIG. 9 is a plan view of a lens array according to this embodiment.

FIG. 10 is a longitudinal sectional view of the lens array, the head substrate, and the like.

FIG. 11 is a perspective view illustrating spots to be formed by the line head.

FIG. 12 is a diagram showing a spot forming operation by the line head.

FIG. 13 is a plan view showing the configuration of a lens array according to a second embodiment.

FIG. 14 is a diagram showing the configuration of a lens surface of a lens.

FIG. 15 is an explanatory view of an advantage of the invention.

FIG. 16 is a plan view showing the configuration of a reverse side of a head substrate of the second embodiment.

FIG. 17 is a plan view showing another example of the configuration of the light emitting element group.

FIG. 18 is a diagram showing a reverse side of a head substrate in which a plurality of light emitting element groups shown in FIG. 17 are arranged.

FIG. 19 is a diagram showing an optical system according to an example.

FIG. 20 is a partial sectional view of a line head and the like according to an example.

FIG. 21 is a diagram showing an optical system specification in an example.

FIG. 22 is a diagram showing data of an optical system including a middle lens.

FIG. 23 is a diagram showing a definitional equation of an XY polynomial surface.

FIG. 24 is a diagram showing the values of coefficients of a surface S4 of an optical system including a middle lens.

FIG. 25 is a diagram showing the values of coefficients of a surface S7 of an optical system including a middle lens.

FIG. 26 is a diagram showing data of an optical system including an upstream lens and a downstream lens.

FIG. 27 is a diagram showing the values of coefficients of a surface S4 of an optical system including an upstream lens and a downstream lens.

FIG. 28 is a diagram showing the values of coefficients of a surface S7 of an optical system including an upstream lens and a downstream lens.

FIG. 29 is a diagram showing another example of numerical values.

FIG. 30 is a diagram showing yet another example of numerical values.

### DESCRIPTION OF EXEMPLARY EMBODIMENTS

Hereinafter, the terms initially used herein will be described (see “A. Description of Terms”). Next to the description of terms, embodiments of the invention will be described (see “B. Embodiments”).

### A. Description of Terms

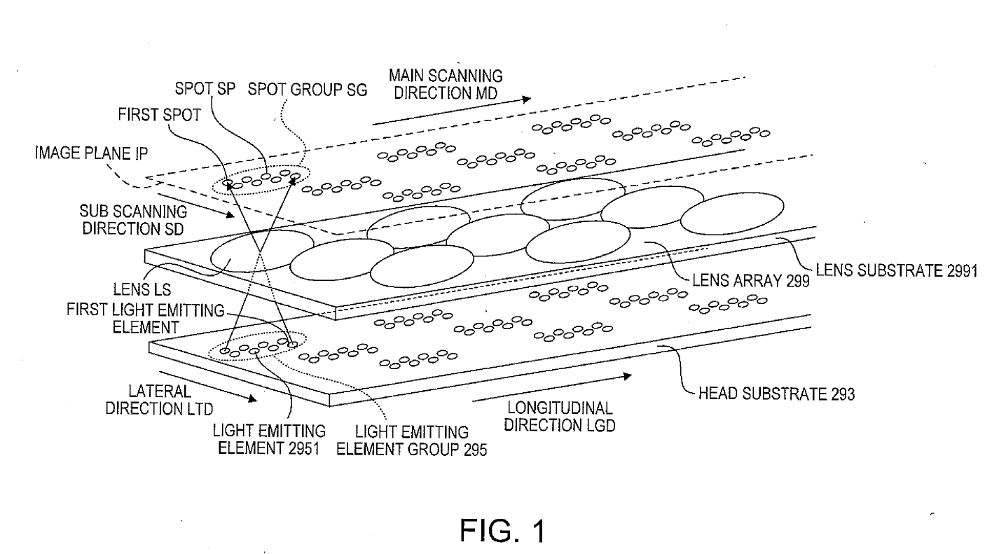

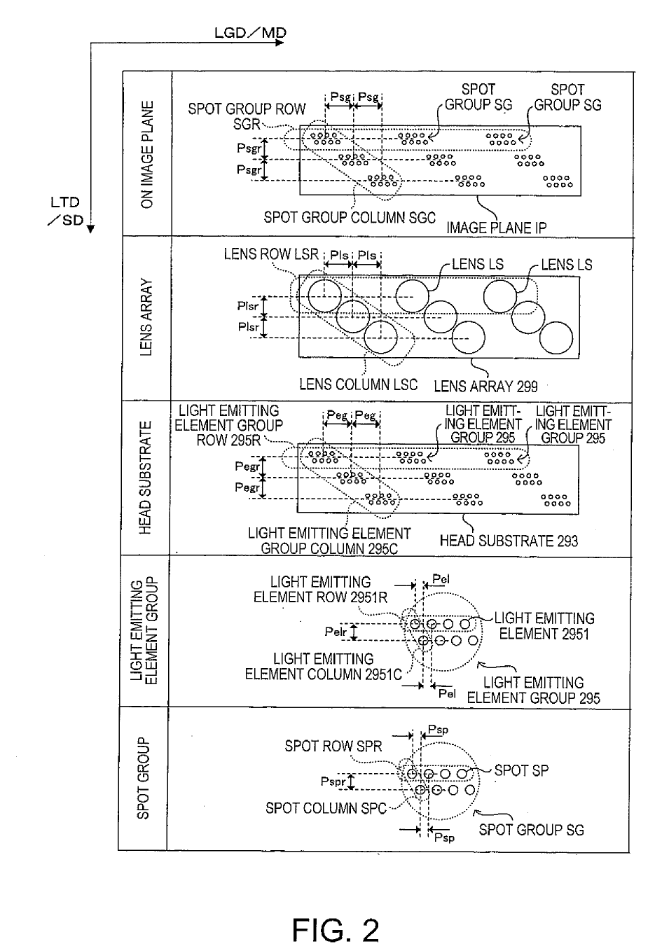

FIGS. 1 and 2 are explanatory views of the terms used herein. The terms used herein will hereinafter be organized with reference to the drawings. Herein, a transport direction of a surface (image plane IP) of a photoconductor drum 21 is defined as a sub scanning direction SD, and a direction perpendicular or substantially perpendicular to the sub scanning direction SD is defined as a main scanning direction MD. A line head 29 is disposed with respect to the surface (image plane IP) of the photoconductor drum 21 such that the longitudinal direction LGD thereof corresponds to the main scanning direction MD, and the lateral direction LTD corresponds to the sub scanning direction SD.

A collection of a plurality (in FIGS. 1 and FIG. 2, eight) of light emitting elements 2951, which are disposed on a head substrate 293 in one-to-one correspondence with a plurality of lenses LS, in a lens array 299 is defined as a light emitting element group 295. That is, on the head substrate 293, a plurality of light emitting element groups 295 each having a plurality of light emitting elements 2951 are disposed to correspond to a plurality of lenses LS. A collection of a plurality of spots SP that are formed on the image plane IP by imaging the light beams from the light emitting element group 295 by the lens LS corresponding to the light emitting element group 295 is defined as a spot group SG. That is, a plurality of spot groups SG can be formed in one-to-one correspondence with a plurality of light emitting element groups 295. The spot on the uppermost stream side in both the main scanning direction MD and the sub scanning direction SD in each spot group SG is specifically defined as first spot. The light emitting element 2951 corresponding to the first spot is specifically defined as a first light emitting element.

As shown in the “ON IMAGE PLANE” column of FIG. 2, a spot group row SGR and a spot group column SGC are defined. That is, a plurality of spot groups SG arranged in the main scanning direction MD are defined as the spot group row SGR. A plurality of spot group rows SGR are arranged in the sub scanning direction SD at a predetermined spot group row pitch Psgr. A plurality (in FIG. 2, three) of spot groups SG arranged in the sub scanning direction SD at a spot group row pitch Psgr and arranged in the main scanning direction MD at a spot group pitch Psg are defined as the spot group column SGC. It should be noted that the spot group row pitch Psgr is a distance in the sub scanning direction SD between the geometric centroids of two adjacent spot group rows SGR in the sub scanning direction SD. In addition, the spot group pitch Psg is a distance in the main scanning direction MD between the geometric centroids of two adjacent spot groups SG in the main scanning direction MD.

As shown in the “LENS ARRAY” column of FIG. 2, a lens row LSR and a lens column LSC are defined. That is, a plurality of lenses LS arranged in the longitudinal direction LGD are defined as the lens row LSR. A plurality of lens rows LSR are arranged in the lateral direction LTD at a predetermined lens row pitch Plsr. A plurality (in FIG. 2, three) of lenses LS arranged in the lateral direction LTD at a lens row pitch Plsr and arranged in the longitudinal direction LGD at a lens pitch Pls are defined as the lens column LSC It should be noted that the lens row pitch Plsr is a distance in the lateral direction LTD between the geometric centroids of two adjacent lens rows LSR in the lateral direction LTD. In addition, the lens pitch Pls is a distance in the longitudinal direction LGD between the geometric centroids of two adjacent lenses LS in the longitudinal direction LGD.

As shown in the “HEAD SUBSTRATE” column of FIG. 2, a light emitting element group row 295R and a light emitting element group column 295C are defined. That is, a plurality of light emitting element groups 295 arranged in the longitudinal direction LGD are defined as the light emitting element group row 295R. A plurality of light emitting element group rows 295R are arranged in the lateral direction LTD at a predetermined light emitting element group row pitch Pegr. A plurality (in FIG. 2, three) of light emitting element groups 295 arranged in the lateral direction LTD at a light emitting element group row pitch Pegr and arranged in the longitudinal direction LGD at a light emitting element group pitch Peg are defined as the light emitting element group column 295C. It should be noted that the light emitting element group row pitch Pegr is a distance in the lateral direction LTD between the geometric centroids of two adjacent light emitting element group rows 295R in the lateral direction LTD. In addition, the light emitting element group pitch Peg is a distance in the longitudinal direction LGD between the geometric centroids of two adjacent light emitting element groups 295 in the longitudinal direction LGD.

As shown in the “LIGHT EMITTING ELEMENT GROUP” column of FIG. 2, a light emitting element row 2951R and a light emitting element column 2951C are defined. That is, a plurality of light emitting elements 2951 arranged in the longitudinal direction LGD in each light emitting element group 295 are defined as the light emitting element row 2951R. A plurality of light emitting element rows 2951R are arranged in the lateral direction LTD at a predetermined light emitting element row pitch Pelr. A plurality (in FIG. 2, two) of light emitting elements 2951 arranged in the lateral direction LTD at a light emitting element row pitch Pelr and arranged in the longitudinal direction LGD at a light emitting element pitch Pel are defined as the light emitting element column 2951C. It should be noted that the light emitting element row pitch Pelr is a distance in the lateral direction LTD between the geometric centroids of two adjacent light emitting element rows 2951R in the lateral direction LTD. In addition, the light emitting element pitch Pel is a distance in the longitudinal direction LGD between the geometric centroids of two adjacent light emitting elements 2951 in the longitudinal direction LGD.

As shown in the “SPOT GROUP” column of FIG. 2, a spot row SPR and a spot column SPC are defined. That is, a plurality of spots SP arranged in the longitudinal direction LGD in each spot group SG are defined as a spot row SPR. A plurality of spot rows SPR are arranged in the lateral direction LTD at a predetermined spot row pitch Pspr. A plurality (in FIG. 2, two) of spots arranged in the lateral direction LTD at a spot row pitch Pspr and arranged in the longitudinal direction LGD at a spot pitch Psp are defined as the spot column SPC. It should be noted that the spot row pitch Pspr is a distance in the sub scanning direction SD between the geometric centroids of two adjacent spot rows SPR in the sub scanning direction SD. In addition, the spot pitch Psp is a distance in the longitudinal direction LGD between the geometric centroids of two adjacent spots SP in the main scanning direction MD.

### B-1. First Embodiment

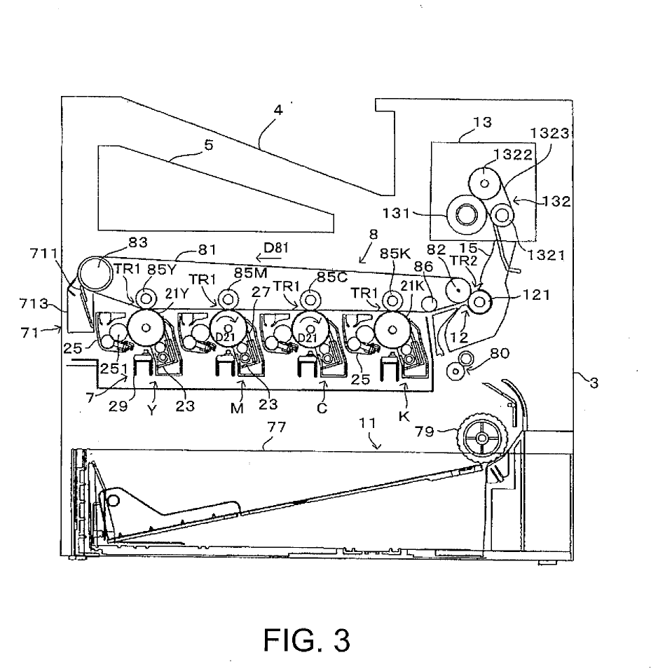

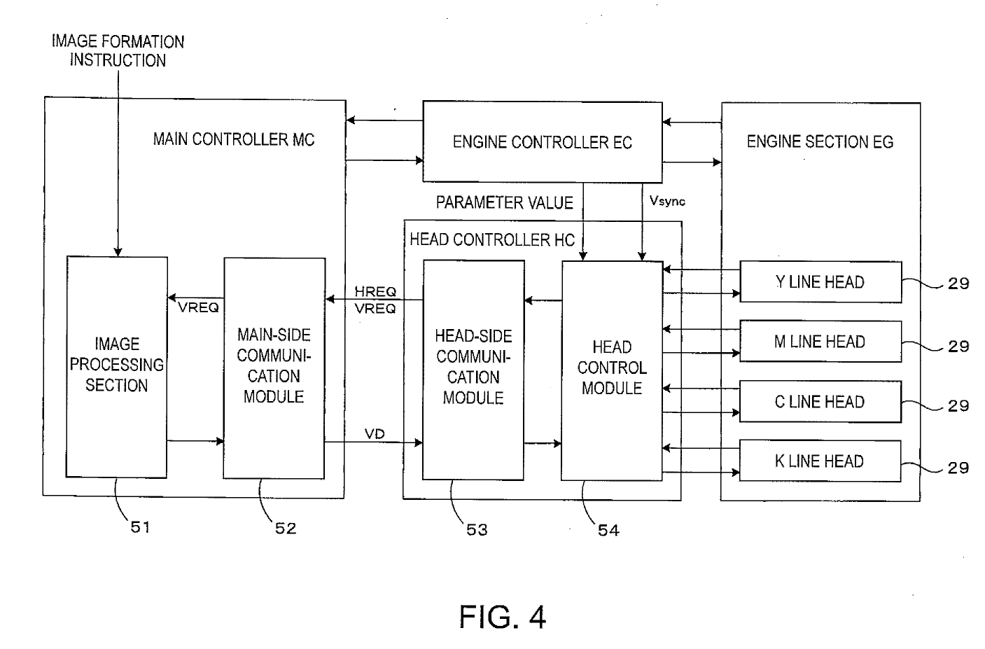

FIG. 3 is a diagram showing an example of an image forming apparatus equipped with line heads, to which the invention is applied. FIG. 4 is a diagram showing the electrical configuration of the image forming apparatus of FIG. 3. This apparatus is an image forming apparatus that can selectively execute a color mode in which a color image is formed by superimposing toner of four colors of black (K), cyan (C), magenta (M), and yellow (Y), and a monochrome mode in which a monochrome image is formed using only toner of black (K) FIG. 3 is a diagram corresponding to a case in which the color mode is executed. In this image forming apparatus, if an image formation instruction is input from an external apparatus, such as a host computer or the like, to a main controller MC having a CPU, a memory, and the like, the main controller MC provides a control signal and the like to an engine controller EC and provides video data VD corresponding to the image formation instruction to a head controller HC. The head controller HC controls line heads 29 of the respective colors on the basis of video data VD from the main controller MC and a vertical synchronizing signal Vsync and parameter values from the engine controller EC. An engine section EG performs a predetermined image forming operation, and forms an image corresponding to the image formation instruction on a sheet, such as copy paper, transfer paper, a form, and an OHP transparent sheet.

Provided inside a main housing 3 of the image forming apparatus is an electric component box 5 housing a power supply circuit board, the main controller MC, the engine controller EC, and the head controller HC. An image forming unit 7, a transfer belt unit 8, and a sheet feed unit 11 are also provided inside the main housing 3. In FIG. 3, on the right side inside the main housing 3, a secondary transfer unit 12, a fixing unit 13, and a sheet guide member 15 are provided. The sheet feed unit 11 is configured so as to be detachably mounted with respect to an apparatus body 1. The sheet feed unit 11 and the transfer belt unit 8 can be separately detached to be repaired or replaced.

The image forming unit 7 includes four image forming stations Y (for yellow), M (for magenta), C (for cyan), and K (for black) for forming images in different colors. Each of the image forming stations Y, M, C, and K is provided with a cylindrical photoconductor drum 21 having a surface with a predetermined length in the main scanning direction MD. Each of the image forming stations Y, M, C, and K forms a toner image of the corresponding color on the surface of the photoconductor drum 21. The photoconductor drum is disposed such that the axial direction thereof is substantially parallel to the main scanning direction MD. Each of the photoconductor drums 21 is connected to a dedicated driving motor and is driven to rotate at a predetermined speed in a direction of an arrow D21 in FIG. 3. Thus, the surface of the photoconductor drum 21 is transported in the sub scanning direction SD perpendicular or substantially perpendicular to the main scanning direction MD. Around the photoconductor drum 21, a charging section 23, the line head 29, a developing section 2S5, and a photoconductor cleaner 27 are disposed along a rotational direction. A charging operation, a latent image forming operation, and a toner developing operation are performed by these functional sections. Therefore, when the color mode is executed, the toner images formed by all the image forming stations Y, M, C, and K are superimposed on a transfer belt 81 of the transfer belt unit 8 to form a color image. When the monochrome mode is executed, a monochrome image is formed using only the toner image formed by the image forming station K. It should be noted that in FIG. 3, since the image forming stations of the image forming unit 7 have the same configuration, for convenience, the reference numerals are provided only to some of the image forming stations, and are omitted in the rest of the image forming stations.

The charging section 23 includes a charging roller having a surface made of elastic rubber. The charging roller is configured so as to be rotated by contact with the photoconductor drum 21 at a charging position, and is rotated in accordance with the rotational operation of the photoconductor drum 21 in a driven direction with respect to the photoconductor drum 21 at a circumferential speed. The charging roller is connected to a charging bias generating section (not shown), is supplied with power for a charging bias from the charging bias generating section, and charges the surface of the photoconductor drum 21 at the charging position where the charging section 23 and the photoconductor drum 21 come into contact with each other.

The line head 29 is disposed with respect to the photoconductor drum 21 such that the longitudinal direction thereof corresponds to the main scanning direction MD, and the lateral direction thereof corresponds to the sub scanning direction SD. The longitudinal direction of the line head 29 is substantially parallel to the main scanning direction MD. The line head 29 has a plurality of light emitting elements arranged in the longitudinal direction, and is separated from the photoconductor drum 21. Light emitted from the light emitting elements is irradiated onto the surface of the photoconductor drum 21 charged by the charging section 23, and therefore an electrostatic latent image is formed on the surface of the photoconductor drum 21.

The developing section 25 has a developing roller 251 having toner born on the surface thereof. A developing bias is applied to the developing roller 251 from a developing bias generating section (not shown) electrically connected to the developing roller 251. Thus, toner is moved from the developing roller 251 to the photoconductor drum 21 at a developing position where the developing roller 251 and the photoconductor drum 21 come into contact with each other, and the electrostatic latent image formed by the line head 29 is visualized.

The toner image visualized at the developing position is moved in the rotational direction D21 of the photoconductor drum 21, and then primary transferred to the transfer belt 81 described below in detail at a primary transfer position TR1 where the transfer belt 81 and each of the photoconductor drums 21 come into contact with each other.

In this embodiment, the photoconductor cleaner 27 is provided on a downstream side of the primary transfer position TR1 and on an upstream side of the charging section 23 in the rotational direction D21 of the photoconductor drum 21 so as to come into contact with the surface of the photoconductor drum 21. The photoconductor cleaner 27 removes residual toner on the surface of the photoconductor drum 21 after the primary transfer to clean the surface of the photoconductor drum by contact with the surface of the photoconductor drum.

The transfer belt unit 8 includes a driving roller 82, a driven roller 83 (blade-opposed roller) provided on a left side of the driving roller 82 in FIG. 3, and a transfer belt 81 stretched between the rollers and circularly driven in a direction (transport direction) of an arrow D81 in FIG. 3. The transfer belt unit 8 includes four primary transfer rollers 85Y, 85M, 85C, and 85K that are disposed inside the transfer belt 81 so as to be opposite to the photoconductor drums 21 in the image forming stations Y, M, C, and K in one-to-one correspondence when photoconductor cartridges are mounted. The primary transfer rollers 85 are electrically connected to a primary transfer bias generating section (not shown). As described below in detail, when the color mode is executed, as shown in FIG. 3, all the primary transfer rollers 85Y, 85M, 85C, and 85K are positioned onto the image forming stations Y, M, C, and K to press the transfer belt 81 against the photoconductor drums 21 in the image forming stations Y, M, C, and K, thereby forming the primary transfer position TR1 between each of the photoconductor drums 21 and the transfer belt 81. Then, a primary transfer bias is applied from the primary transfer bias generating section to the primary transfer rollers 85 with appropriate timing. Thus, the toner images formed on the surfaces of the photoconductor drums 21 are transferred to the surface of the transfer belt 81 at the respective primary transfer position TR1 to form a color image.

When the monochrome mode is executed, the color primary transfer rollers 85Y, 85M, and 85C from among the four primary transfer rollers 85 are separated from the image forming stations Y, M, and C correspondingly opposite to the color primary transfer rollers 85Y, 85M, and 85C, and only the monochrome primary transfer roller 85K comes into contact with the image forming station K. That is, only the monochrome image forming station K comes into contact with the transfer belt 81. As a result, the primary transfer position TR1 is formed only between the monochrome primary transfer roller 85K and the image forming station K. Then, the primary transfer bias is applied from the primary transfer bias generating section to the monochrome primary transfer roller 85K with appropriate timing. Thus, the toner image formed on the surface of the photoconductor drum 21 is transferred to the surface of the transfer belt 81 at the primary transfer position TR1 to form a monochrome image.

The transfer belt unit 8 includes a downstream guide roller 86 that is provided on a downstream side of the monochrome primary transfer roller 85K and an upstream side of the driving roller 82. The downstream guide roller 86 is configured to come into contact with the transfer belt 81 on a common internal tangent of the primary transfer roller 85K and the photoconductor drum 21 at the primary transfer position TR1 formed by contact of the monochrome primary transfer roller 85K with the photoconductor drum 21 of the image forming station K.

The driving roller 82 is circularly driven in the direction of the arrow D81 in FIG. 3 of the transfer belt 81, and also functions as a backup roller of a secondary transfer roller 121. On the peripheral surface of the driving roller 82, a rubber layer with a thickness of about 3 mm and volume resistivity of no greater than 1000 kΩ·cm is formed. When being grounded through a metal shaft, the rubber layer functions as a conduction path of a secondary transfer bias to be supplied from a secondary transfer bias generating section (not shown) through the secondary transfer roller 121. If the rubber layer having high abrasion resistance and a shock absorption property is provided in the driving roller 82, a shock caused by a sheet entering a contact portion (secondary transfer position TR2) of the driving roller 82 and the secondary transfer roller 121 is difficult to be transmitted to the transfer belt 81, and thus deterioration of image quality can be prevented.

The sheet feed unit 11 includes a sheet feed portion that has a sheet feed cassette 77 that can hold a stack of sheets, and a pickup roller 79 that feeds the sheet one by one from the sheet feed cassette 77. The sheet fed by the pickup roller 79 from the sheet feed section is fed to the secondary transfer position TR2 along the sheet guide member 15 after the feed timing thereof is adjusted by a pair of register rollers 80.

The secondary transfer roller 121 is provided so as to be freely separated from or come into contact with the transfer belt 81, and is driven to be separated from or come into contact with the transfer belt 81 by a secondary transfer roller driving mechanism (not shown). The fixing unit 13 has a rotatable heating roller 131 that has an internal heater, such as a halogen heater, and a pressing section 132 that presses and urges a heating roller 131. The sheet with the image secondary transferred to the surface thereof is guided by the sheet guide member 15 to a nip portion, which is formed between the heating roller 131 and a pressing belt 1323 of the pressing section 132, and the image is thermally fixed in the nip portion at a predetermined temperature. The pressing section 132 has two rollers 1321 and 1322, and the pressing belt 1323 stretched between the rollers 1321 and 1322. If a tensioned part of the surface of the pressing belt 1323 stretched by the two rollers 1321 and 1322 is pressed against the peripheral surface of the heating roller 131, the nip portion formed between the heating roller 131 and the pressing belt 1323 increases. The sheet subjected to the fixing process is fed to a sheet discharge tray 4 provided in an upper surface of the main housing 3.

In this apparatus, a cleaner section 71 is provided so as to be opposite to the blade-opposed roller 83. The cleaner section 71 has a cleaner blade 711 and a waste toner box 713. The cleaner blade 711 removes foreign substances, such as residual toner on the transfer belt after the secondary transfer or paper dust, by bringing a tip portion thereof into contact with the blade-opposed roller 83 through the transfer belt 81. The thus-removed foreign substances are collected into the waste toner box 713. The cleaner blade 711 and the waster toner box 713 are formed integrally with the blade-opposed roller 83. Therefore, as described below, when the blade-opposed roller 83 moves, the cleaner blade 711 and the waste toner box 713 also move together with the blade-opposed roller 83.

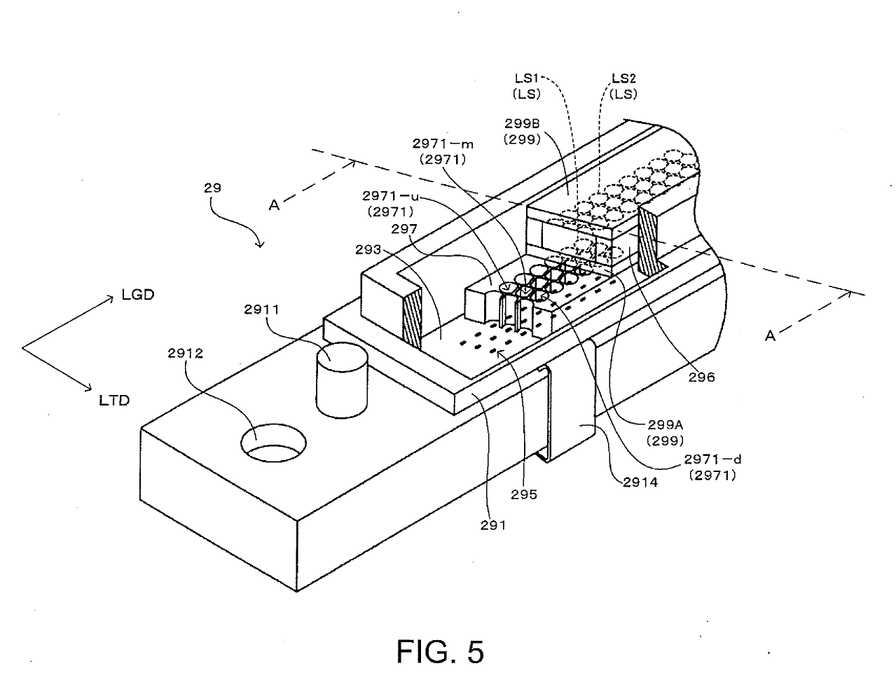

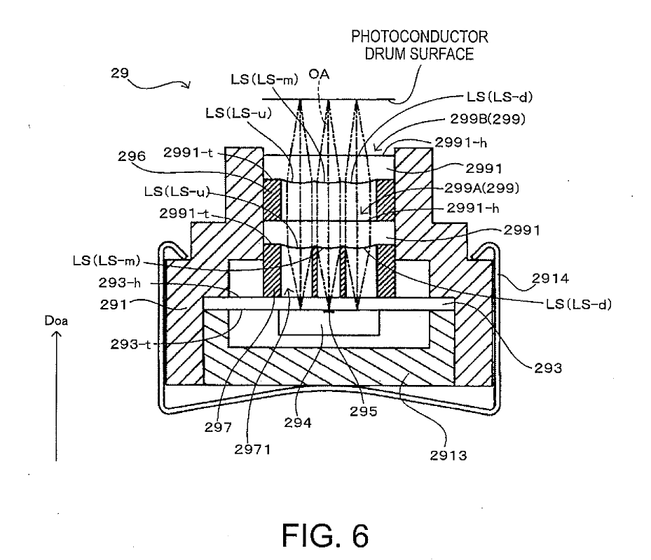

FIG. 5 is a perspective view schematically showing the line head according to this embodiment. FIG. 6 is a partial sectional view of the line head taken along the line A-A of FIG. 5. The line A-A is a line including the optical axis of each of lenses constituting a lens column described below. FIG. 6 shows a section parallel to the optical axis of the lens including the line A-A. As described above, the line head 29 is disposed with respect to the photoconductor drum 21 such that the longitudinal direction LGD thereof corresponds to the main scanning direction MD, and the lateral direction LTD thereof corresponds to the sub scanning direction SD. It should be noted that the longitudinal direction LGD and the lateral direction LTD are perpendicular or substantially perpendicular to each other. As described below, in the line head 29, a plurality of light emitting elements are formed on the head substrate 293, and each of the light emitting elements emits a light beam toward the surface of the photoconductor drum 21. In this specification, a direction perpendicular to the longitudinal direction LGD and the lateral direction LTD, and from the light emitting element toward the surface of the photoconductor drum is called a beam travel direction Doa. The beam travel direction Doa is parallel or substantially parallel to an optical axis OA described below.

The line head 29 includes a case 291, and positioning pins 2911 and screw insertion holes 2912 are provided at both ends of the case 291 in the longitudinal direction LGD. The positioning pins 2911 are fitted into positioning holes (not shown) provided in a photoconductor cover (not shown) covering the photoconductor drum 21 and being positioned with respect to the photoconductor drum 21, thereby positioning the line head 29 with respect to the photoconductor drum 21. In addition, set screws are screwed into and fixed to screw holes (not shown) of the photoconductor cover through the screw insertion holes 2912, thereby positioning and fixing the line head 29 with respect to the photoconductor drum 21.

Inside the case 291, the head substrate 293, a light shielding member 297, and two lens arrays 299 (299A and 299B) are disposed. The inside of the case 291 comes into contact with a surface 293-h of the head substrate 293, and a back lid 2913 comes into contact with a reverse side surface 293-t of the head substrate 293. The back lid 2913 is pressed into contact with the inside of the case 291 through the head substrate 293 by a retainer 2914. That is, the retainer 2914 has an elastic force for pressing the back lid 2913 against the inside of the case 291 (an upper side in FIG. 6). The back lid is pressed by the elastic force, and thus the inside of the case 291 is sealed light-tightly (in other words, such that light does not leaks from the inside of the case 291 and such that light does not enter from the outside of the case 291). It should be noted that the retainer 2914 is provided in each of a plurality of positions of the case 291 in the longitudinal direction LGD.

On the reverse side surface 293-t of the head substrate 293, a light emitting element group 295 having a plurality of light emitting elements is provided. The head substrate 293 is formed of a light-transmissive member, such as glass, and the light beam emitted from each of the light emitting elements in the light emitting element group 295 can transmit from the reverse side surface 293-t of the head substrate 293 to the surface 293-h. The light emitting element is a bottom emission type organic EL (Electro-Luminescence) element, and is covered with a seal member 294. The details of the arrangement of the light emitting elements on the reverse side surface 293-t of the head substrate 293 are as follows.

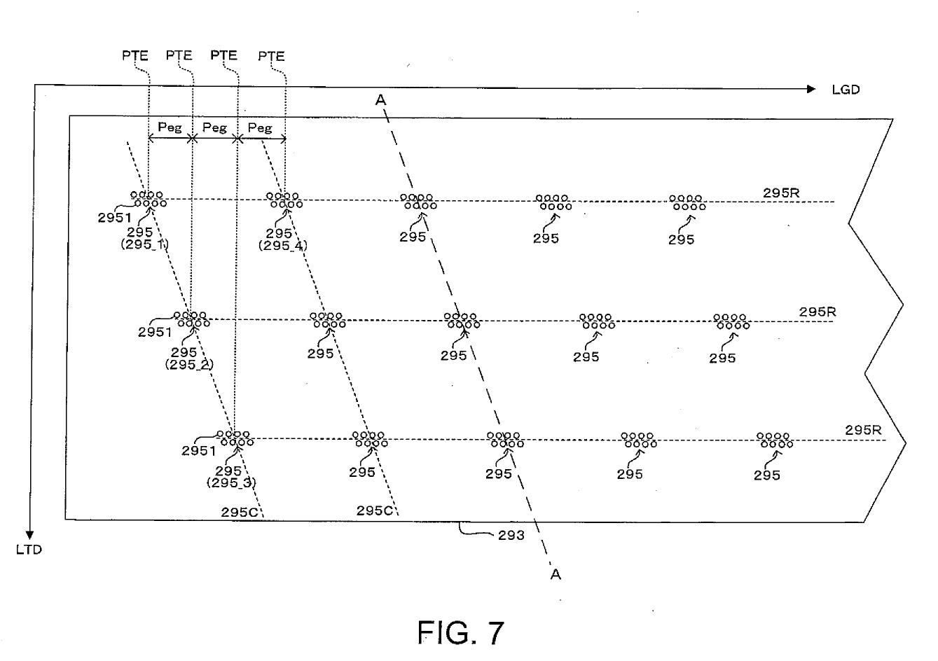

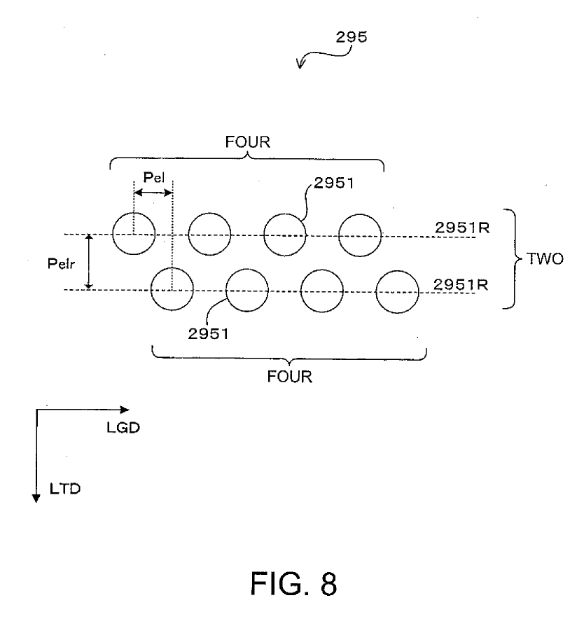

FIG. 7 is a diagram showing the configuration of the reverse side surface of the head substrate, and corresponds to a case in which the reverse side surface is viewed from the surface of the head substrate. FIG. 8 is a diagram showing the configuration of light emitting element groups provided on the reverse side surface of the head substrate. As shown in FIG. 7, each of the light emitting element groups 295 has eight light emitting elements 2951. In each of the light emitting element groups 295, the eight light emitting elements 2951 are arranged as follows. That is, as shown in FIG. 8, in each of the light emitting element groups 295, four light emitting elements 2951 are arranged in the longitudinal direction LGD to form the light emitting element row 2951R, and two light emitting element rows 2951R are arranged in the lateral direction LTD at the light emitting element row pitch Pelr. The light emitting element rows 2951R are out of alignment in the longitudinal direction LGD by the element pitch Pel, and the light emitting elements 2951 are located at different positions in the longitudinal direction LGD.

On the reverse side surface 293-t of the head substrate 293, a plurality of light emitting element groups 295 configured as described above are arranged. That is, three light emitting element groups 295 are arranged at different positions in the lateral direction LTD to form the light emitting element group column 295C, and a plurality of light emitting element group columns 295C are arranged along the longitudinal direction LGD. In each of the light emitting element group columns 295C, three light emitting element groups 295 are out of alignment in the longitudinal direction LGD by the light emitting element group pitch Peg. As a result, the positions PTE of the light emitting element groups 295 in the longitudinal direction LGD are different from each other. In other words, on the reverse side surface 293-t of the head substrate 293, a plurality of light emitting element groups 295 are arranged in the longitudinal direction LGD to form the light emitting element group row 295R, and three light emitting element group rows 295R are provided in the lateral direction LTD. The light emitting element group rows 295R are out of alignment in the longitudinal direction LGD by the light emitting element group pitch Peg. As a result, the positions PTE of the light emitting element groups 295 in the longitudinal direction LGD are different from each other. As described above, in this embodiment, a plurality of light emitting element groups 295 are arranged on the head substrate 293 in a two-dimensional manner. In FIG. 7, the position of each of the light emitting element group 295 is represented by the gravity center position of the light emitting element group 295, and the position PTE of the light emitting element group 295 in the longitudinal direction LGD is indicated by a foot of a perpendicular drawn down from the position of the light emitting element group 295 in the longitudinal direction LGD.

The light emitting elements 2951 formed on the head substrate 293 in the above-described manner are driven by, for example, a TFT (Thin Film Transistor) circuit or the like, and emit light beams having the same wavelength. A light emitting surface of each of the light emitting elements 2951 is a so-called perfect diffuse surface light source, and a light beam emitted from the light emitting surface follows the Lamberts' cosine law.

The description will be continued with reference to FIGS. 5 and 6 again. The light shielding member 297 is arranged so as to come into contact with the surface 293-h of the head substrate 293. The light shielding member 297 is provided with a light guide hole 2971 for each of a plurality of light emitting element groups 295 (in other words, a plurality of light guide holes 2971 are provided in one-to-one correspondence with a plurality of light emitting element groups 295). Each of the light guide holes 2971 passes through the light shielding member 297 in the beam travel direction Doa. On an upper side of the light shielding member 297 (a side opposite to the head substrate 293), two lens arrays 299 are arranged in the beam travel direction Doa.

As described above, the light shielding member 297 that is provided with the light guide hole 2971 for each light emitting element group 295 is arranged between the light emitting element group 295 and the lens array 299 in the beam travel direction Doa. Therefore, the light beams emitted from the light emitting element group 295 pass through the light guide hole 2971 corresponding to the light emitting element group 295 and go toward the lens array 299. To put it the other way around, from among the light beams emitted from the light emitting element group 295, a light beam toward the light guide holes 2971 other than the light guide hole 2971 corresponding to the light emitting element group 295 is shielded by the light shielding member 297. In this way, the light beams emitted from one light emitting element group 295 all go toward the lens array 299 through the same light guide hole 2971, and inference between light beams emitted from different light emitting element group 295 is prevented by the light shielding member 297.

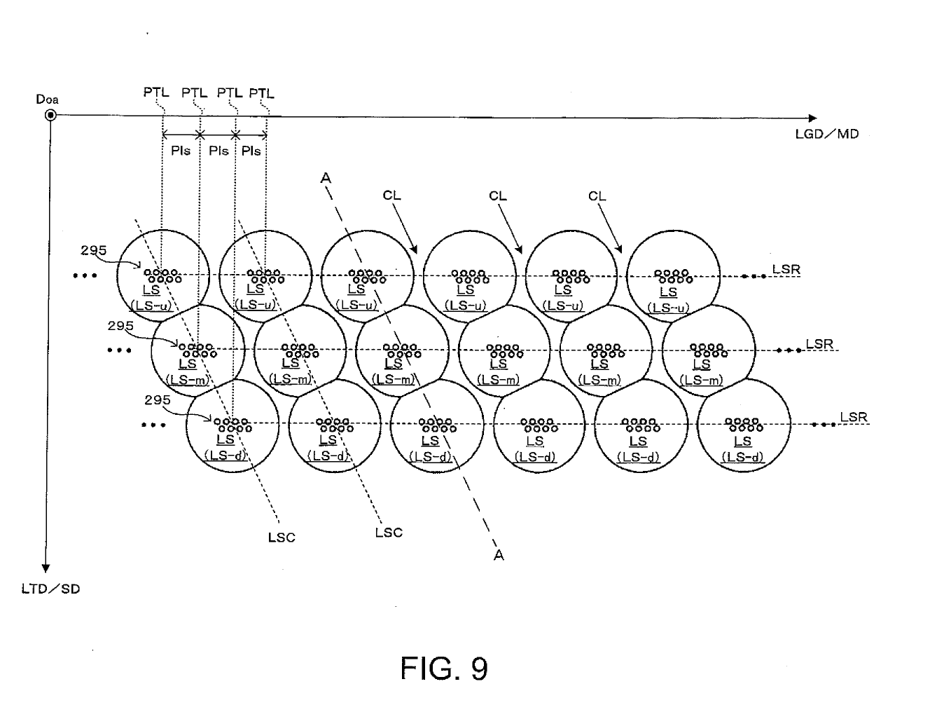

FIG. 9 is a plan view of the lens array according to this embodiment, and corresponds to a case in which the lens array is viewed from the image plane side (the beam travel direction Doa side). In FIG. 9, the lenses LS are formed on a reverse side surface 2991-t of a lens array substrate 2991. FIG. 9 shows the configuration of the reverse side surface 2991-t of the lens array substrate. In FIG. 9, the light emitting element groups 295 are described. However, this is for illustrative of the correspondence between the light emitting element groups 295 and the lenses LS, but not intended to indicate that the light emitting element groups 295 are provided on the reverse side surface 2991-t of the lens array substrate. In the lens array 299, the lens LS is provided for each light emitting element group 295. That is, in the lens array 299, three lenses LS are arranged at different positions in the lateral direction LTD to form the lens column LSC, and a plurality of lens columns LSC are arranged along the longitudinal direction LGD. In each of the lens columns LSC, three lenses are arranged so as to be out of alignment in the longitudinal direction LGD by the lens pitch Pls. As a result, the positions PTL of the lenses LS in the longitudinal direction LGD are different from each other.

In other words, in the lens array 299, a plurality of lenses LS are arranged in the longitudinal direction LGD to form the lens row LSR, and three lens rows LSR are provided in the lateral direction LTD. The lens rows LSR are arranged so as to be out of alignment in the longitudinal direction LGD by the lens pitch Pls, and the positions PTL of the lenses LS in the longitudinal direction LGD are different from each other. As described above, in the lens array 299, a plurality of lenses LS are arranged in a two-dimensional manner. In FIG. 9, the position of each of the lenses LS is represented by the vertex of the lens LS (that is, a point where the sag has a maximum value), and the position PTL of the lens LS in the longitudinal direction LGD is indicated by a foot of a perpendicular drawn down from the vertex of the lens LS in the longitudinal direction LGD.

As shown in FIG. 9, in this embodiment, adjacent lenses LS in each of the lens column LSC are connected to each other. That is, in each of the lens columns LSC, an upstream lens LS-u and a middle lens LS-m are connected to each other, and the middle lens LS-m and a downstream lens LS-d are connected to each other. A clearance CL is provided between the lens columns LSC in the longitudinal direction LGD, and the lens columns LSC are arranged so as to be separated from each other. The upstream lens LS-u is a lens LS belonging to the lens row LSR on the uppermost stream side in the lateral direction LTD, the middle lens LS-m is a lens LS belonging to the middle lens row LSR in the lateral direction LTD, and the downstream lens LS-d is a lens LS belonging to the lens row LSR on the lowermost stream side in the lateral direction LTD.

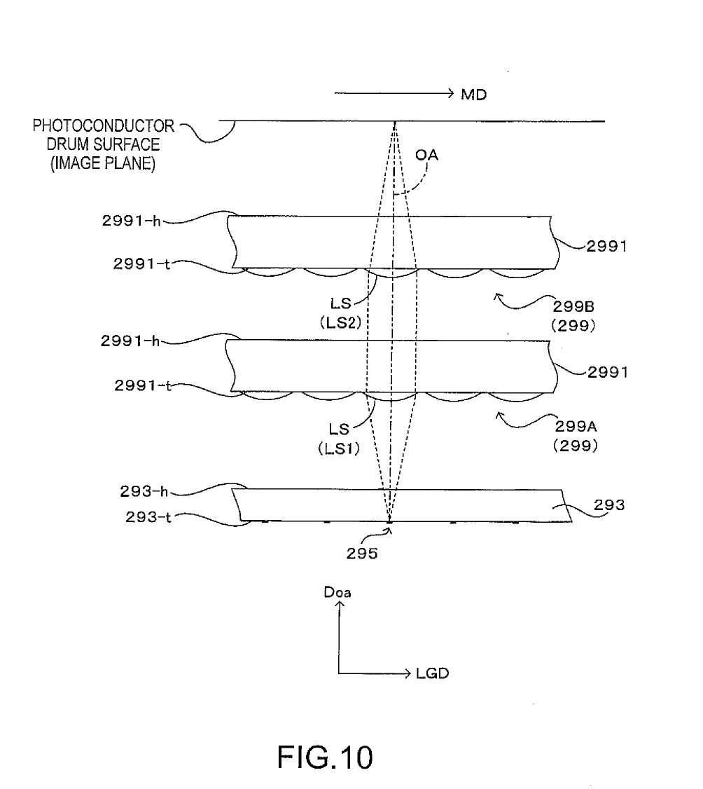

FIG. 10 is a sectional view of the lens array, the head substrate, and the like as viewed from the longitudinal direction, and shows a section in the longitudinal direction including the optical axis of each lens Ls in the lens array. The lens array 299 is long in the longitudinal direction LGD and has a light-transmissive lens array substrate 2991. That is, the length of the lens array substrate 2991 in the longitudinal direction LGD (first direction) is longer than the length (width) of the lens array substrate 2991 in the lateral direction LTD (second direction). In this embodiment, the lens array substrate 2991 is formed of glass having a comparatively small linear expansion coefficient. The lenses LS are formed on the reverse side surface 2991-t of the lens array substrate 2991 from among the surface 2991-h and the reverse side surface 2991-t of the lens array substrate 2991. The lens array 299 is formed by the method described in JP-A-2005-276849 or the like. Specifically, a mold having concave portions according to the shape of each lens LS comes into contact with a glass substrate serving as the lens array substrate 2991. Photocurable resin is filled between the mold and the light-transmissive substrate. If light is irradiated onto the photocurable resin, the photocurable resin is cured, and the lenses LS are formed on the light-transmissive substrate. After the photocurable resin is cured and the lenses LS are formed, the mold is released. As described above, in this embodiment, the lenses LS are formed of photocurable resin that can be rapidly cured by light irradiation. Therefore, the lenses LS can be simply formed, and thus a process for creating the lens array 299 can be simplified to reduce costs for the lens array 299. In addition, since the lens array substrate 2991 is formed of glass having a small linear expansion coefficient, the lens array 299 can be prevented from being deformed due to a change in temperature, and as a result, preferable exposure can be achieved without depending on the temperature.

In the line head 29, two lens arrays 299 (299A and 299B) having the above-described configuration are arranged in the beam travel direction Doa, and two lenses LS1 and LS2 arranged in the beam travel direction Doa are disposed for each light emitting element group 295 (FIGS. 5, 6, and 10). The optical axis OA (in FIG. 10, a two-dot-chain line) passing through the center of the first lens LS1 and the second lens LS2 corresponding to the same light emitting element group 295 is perpendicular or substantially perpendicular to the reverse side surface 293-t of the head substrate 293. The lens of the upstream-side lens array 299A in the beam travel direction Doa is the first lens LS1, and the lens LS of the downstream-side lens array 299B in the beam travel direction Doa is the second lens LS2. As described above, in this embodiment, a plurality of lens arrays 299 are arranged in the beam travel direction Doa, and thus a degree of freedom of optical design can be improved.

As described above, the line head 29 includes an optical system having the first and second lenses LS1 and LS2. Therefore, the light beams emitted from the light emitting element group 295 are imaged by the first lens LS1 and the second lens LS2, and the spots SP are formed on the surface (image plane) of the photoconductor drum. Meanwhile, as described above, the surface of the photoconductor drum is charged by the charging section 23 before the spots are formed. Therefore, regions where the spots SP are formed are neutralized, and spot latent images Lsp are formed. The thus-formed spot latent images Lsp are born on the surface of the photoconductor drum and sent toward the downstream side in the sub scanning direction SD. Then, as described below, the spots SP are formed with timing according to the movement of the surface of the photoconductor drum, and thus a plurality of spot latent images Lsp are formed so as to be arranged in the main scanning direction MD.

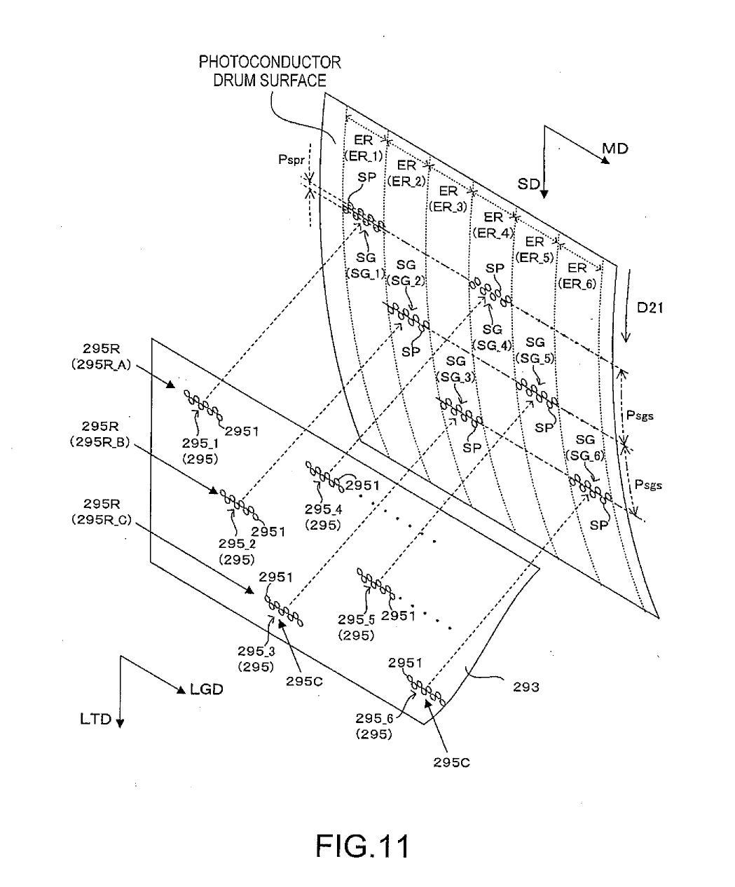

FIG. 11 is a perspective view illustrating spots to be formed by the line head. In FIG. 11, the lens array 299 is omitted. As shown in FIG. 11, each of the light emitting element groups 295 can form spot groups SG indifferent exposure regions ER in the main scanning direction MD. Each of the spot groups SG is a collection of a plurality of spots SP to be formed when all the light emitting elements 2951 of the light emitting element group 295 simultaneously emit light. As shown in FIG. 11, three light emitting element groups 295 that can form the spot groups SG in the successive exposure regions ER in the main scanning direction MD are disposed so as to be out of alignment in the lateral direction LTD. For example, three light emitting element groups 295_1, 295_2, and 295_3 that can form spot groups SG_1, SG_2, and SG_3 in successive exposure regions ER_1, ER_2, and ER_3 in the main scanning direction MD are disposed so as to be out of alignment in the lateral direction LTD. The three light emitting element group 295 form the light emitting element group column 295C, and a plurality of light emitting element group columns 295C are arranged along the longitudinal direction LGD. As a result, as described with reference to FIG. 7, three light emitting element group rows 295R_A, 295R_B, and 295R_C are arranged in the lateral direction LTD, and the light emitting element group row 295R_A or the like forms the spot groups SG at different positions in the sub scanning direction SD.

Specifically, in the line head 29, a plurality of light emitting element groups 295 (for example, light emitting element groups 295_1, 295_2, and 295_3) are disposed at different positions in the lateral direction LTD. The light emitting element groups 295 disposed at different positions in the lateral direction LTD form spot groups SG (for example, spot groups SG_1, SG_2, and SG_3) in the sub scanning direction SD.

In other words, in the line head 29, a plurality of light emitting element 2951 are disposed at difference positions in the lateral direction LTD (for example, the light emitting element 2951 belonging to the light emitting element group 295_1 and the light emitting element 2951 belonging to the light emitting element group 295_2 are disposed at different positions in the lateral direction LTD). The light emitting elements 2951 disposed at different positions in the lateral direction LTD form the spots SP at different positions in the sub scanning direction SD (for example, the spot SP belonging to the spot group SG_1 and the spot SP belonging to the spot group SG_2 are formed at different positions in the sub scanning direction SD).

As described above, the forming positions of the spots SP in the sub scanning direction SD by the light emitting elements 2951 are different from each other. Therefore, in order to form a plurality of spot latent images Lsp arranged in the main scanning direction MD (that is, in order to form a plurality of spot latent images Lsp at the same positions in the sub scanning direction SD), a difference between the spot forming positions should be taken into consideration. Therefore, in the line head 29, the light emitting elements 2951 emit light with timing according to the movement of the surface of the photoconductor drum.

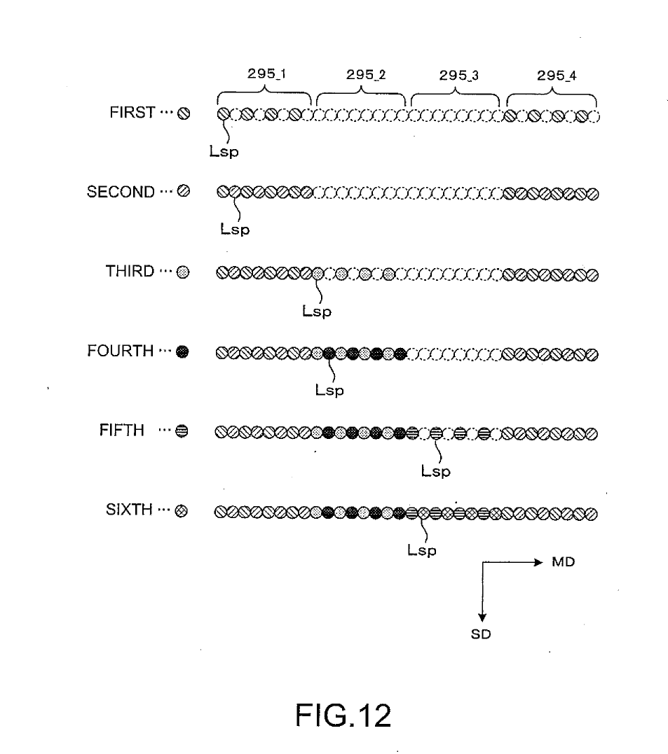

FIG. 12 is a diagram showing a spot forming operation by the above-described line head. A spot forming operation by the line head will hereinafter be described with reference to FIGS. 7, 11, and 12. Schematically, the surface of the photoconductor drum (a surface of a latent image carrier) moves in the sub scanning direction SD, and a head control module 54 (FIG. 4) causes the light emitting elements 2951 to emit light with timing according to the movement of the surface of the photoconductor drum. Thus, a plurality of spot latent images Lsp arranged in the main scanning direction MD are formed.

First, from among the light emitting element rows 2951R belonging to the light emitting element groups 295_1, 295_4 on the uppermost stream side in the lateral direction LTD (FIG. 11), the light emitting element rows 2951R on the downstream side in the lateral direction LTD perform the light emission operation. Then, a plurality of light beams to be emitted by this light emission operation are imaged by the lenses LS, and the spots SP are formed on the surface of the photoconductor drum The lenses LS have an inversion characteristic, and thus the light beams from the light emitting elements 2951 are inverted and imaged. Therefore, the spot latent images Lsp are formed at the positions corresponding to the hatched patterns in the “FIRST” line of FIG. 12. In FIG. 12, the outline circles indicate spot latent images that are not formed yet but to be formed subsequently. In addition, in FIG. 12, reference numerals 295_1 to 295_4 represent spot latent images formed by the corresponding light emitting element groups 295.

Next, from among the light emitting element rows 2951R belonging to the light emitting element groups 295_1, 295_4, the light emitting element rows 2951R on the upstream side in the lateral direction LTD perform the light emission operation. Then, a plurality of light beams emitted by this light emission operation are imaged by the lenses LS, and the spots SP are formed on the surface of the photoconductor drum. Therefore, the spot latent images Lsp are formed at the positions corresponding to the hatched patterns in the “SECOND” line of FIG. 12. The reason why the light emission operation is performed in sequence from the light emitting element rows 2951R on the downstream side in the lateral direction LTD is that the lenses LS have an inversion characteristic.

Next, from among the light emitting element rows 2951R belonging to the light emitting element group 295_2 and the like on the second uppermost stream side in the lateral direction, the light emitting element rows 2951R on the downstream side in the lateral direction LTD perform the light emission operation. Then, a plurality of light beams emitted by this light emission operation are imaged by the lenses LS, and the spots SP are formed on the surface of the photoconductor drum. Therefore, the spot latent images Lsp are formed at the positions corresponding to the hatched patterns in the “THIRD” line of FIG. 12.

Next, from among the light emitting element rows 2951R belonging to the light emitting element group 295_2 and the like on the second uppermost stream side in the lateral direction, the light emitting element rows 2951R on the upstream side in the lateral direction LTD perform the light emission operation. Then, a plurality of light beams emitted by this light emission operation are imaged by the lenses LS, and the spots SP are formed on the surface of the photoconductor drum. Therefore, the spot latent images Lsp are formed at the positions corresponding to the hatched patterns in the “FOURTH” line of FIG. 12.

Next, from among the light emitting element rows 2951R belonging to the light emitting element group 295_3 and the like on the third uppermost stream side in the lateral direction, the light emitting element rows 2951R on the downstream side in the lateral direction LTD perform the light emission operation. Then, a plurality of light beams emitted by this light emission operation are imaged by the lenses LS, and the spots SP are formed on the surface of the photoconductor drum. Therefore, the spot latent images Lsp are formed at the positions corresponding to the hatched patterns in the “FIFTH” line of FIG. 12.

Finally, from among the light emitting element rows 2951R belonging to the light emitting element group 295_3 and the like on the third uppermost stream side in the lateral direction, the light emitting element rows 2951R on the upstream side in the lateral direction LTD perform the light emission operation. Then, a plurality of light beams emitted by this light emission operation are imaged by the lenses LS, and the spots SP are formed on the surface of the photoconductor drum. Therefore, the spot latent images Lsp are formed at the positions corresponding to the hatched patterns in the “SIXTH” line of FIG. 12. In this way, by executing the first to sixth light emission operations, the spots SP are formed in sequence from the spots SP on the upstream side in the sub scanning direction SD, and thus a plurality of spot latent images Lsp arranged in the main scanning direction MD are formed.

As described above, in this embodiment, a plurality of lenses LS are provided on the light-transmissive lens array substrate 2991. On the lens array substrate 2991, a plurality of lens columns LSC each having a plurality of lenses LS arranged at different positions in the lateral direction LTD (second direction) are arranged in the longitudinal direction LGD (second direction). Adjacent lenses LS in each of the lens columns LSC are connected to each other. That is, in each of the lens columns LSC, no clearance is provided between adjacent lenses LS, and adjacent lenses LS are connected to each other. Therefore, the lenses LS can be adapted to receive a large amount of light, without increasing the lens pitch (Corresponding to the lens row pitch Plsr) in the lateral direction LTD in each of the lens columns LSC. The lens array 299 of this embodiment can cope with exposure with high resolution, is reduced in size, and is preferable. With this lens array 299, the line head 29 or the image forming apparatus 1 can be reduced in size.

In this embodiment, the clearance CL is provided between adjacent the lens columns LSC in the longitudinal direction LGD on the lens array substrate 2991. Therefore, the lens array 299 can be prevented from being flexed due to a change in temperature, and thus this embodiment is preferable. When no clearance CL is provided between adjacent lens columns LSC in the longitudinal direction LGD, and the lenses LS are connected to each other between adjacent lens columns LSC, a plurality of lenses LS arranged in the longitudinal direction LGD are connected to each other. In this case, since the lenses LS are formed of photocurable resin, resin is stretched in the longitudinal direction LGD on the lens array substrate 2991. In other words, a long agglomerate of resin in the longitudinal direction LGD is formed on the lens array substrate 2991. The resin has a comparatively larger linear expansion coefficient than glass as a base material of the lens array substrate 2991. For this reason, while the agglomerate of resin significantly expands and contracts in the longitudinal direction LGD due to the change in temperature, the amount of expansion and contraction of the lens array substrate 2991 in the longitudinal direction LGD is comparatively small. As a result, if the temperature changes, the lens array 299 may be flexed. In contrast, in this embodiment, the clearance CL is provided between adjacent lens columns LSC in the longitudinal direction LGD, and thus occurrence of flex is suppressed

In this embodiment, an organic EL element is used as the light emitting element 2951, and since the organic EL element has a light amount smaller than an LED (Light Emitting Diode) or the like, the amount of light received by the lens LS tends to become small. In particular, when a bottom emission type organic EL element is used, some of light beams emitted from the organic EL element are absorbed by the head substrate 293, and accordingly the amount of light received by the lens LS becomes smaller. In contrast, in this embodiment, adjacent lenses LS in each of the lens columns LSC are connected to each other, and thus the lenses LS can receive a large amount of light. Therefore, even in the configuration in which a bottom emission type organic EL element is used as the light emitting element 2951, preferable exposure can be performed.

### B-2. Second Embodiment

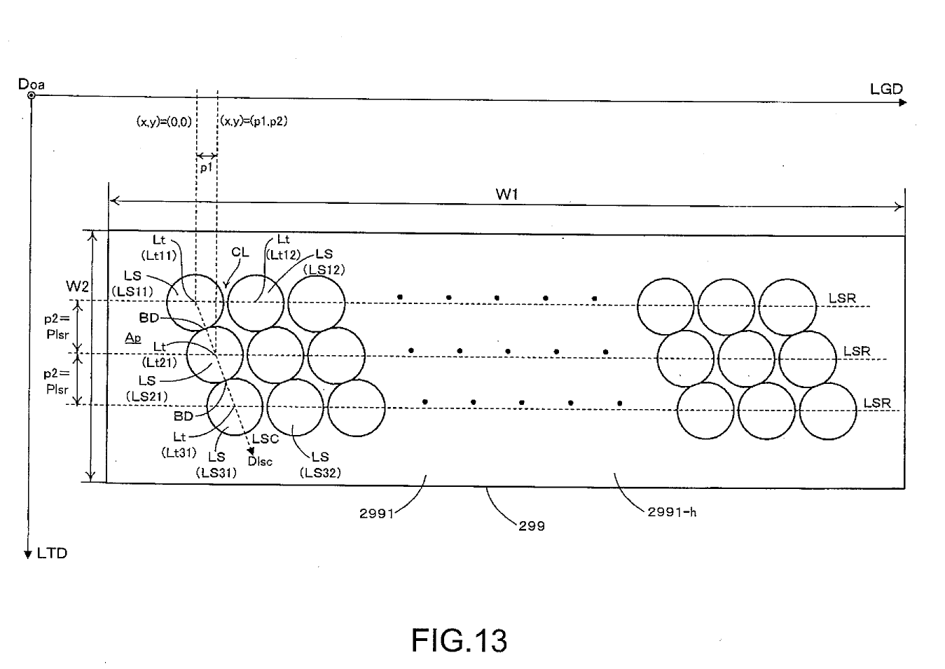

FIG. 13 is a plan view showing the configuration of a lens array according to a second embodiment. A lens array 299 includes a lens array substrate 2991 (light-transmissive substrate) with glass as a base material. In this way, the lens array substrate 2991 is formed of a glass material having a comparatively small linear expansion coefficient, thereby preventing the lens array 299 from being deformed due to a change in temperature. The lens array substrate 2991 has a length W1 in the longitudinal direction LGD and a width W2 (length W2) in the lateral direction LTD. The condition of the length W1>the width W2 is satisfied, and the lens array substrate 2991 is long in the longitudinal direction LGD. A plurality of lenses LS formed of photocurable resin (resin material) are formed on the surface 2991-h of the lens array substrate 2991 by the above-described method using a mold. A plurality of lenses LS are disposed in a two-dimensional manner. Specifically, three lenses LS are arranged in a lens row arrangement direction Disc to form one lens column LSC. In addition, a plurality of lens columns LSC are arranged in the longitudinal direction LGD. A clearance CL is provided between adjacent lens columns LSC in the longitudinal direction LGD. The three lenses constituting each of the lens columns LSC are out of alignment in the longitudinal direction LGD by an interval p1 (=Pls) and are out of alignment in the lateral direction LTD by an interval p2 (=Plsr). In this embodiment, adjacent lenses LS in the lens row arrangement direction Dlsc are connected to each other. In FIG. 13, symbol BD is provided to the boundary of two adjacent lenses LS. A flat region where no lens LS is formed is denoted as a flat region Ap.

In FIG. 13, the x-y coordinate (x,y) is used to represent the position on the surface 2991-h of the lens array substrate. The x axis is a coordinate axis parallel or substantially parallel to the longitudinal direction LGD, and the y axis is a coordinate axis parallel or substantially parallel to the lateral direction LTD. The x axis and the y axis are perpendicular to each other. In the x-y coordinate, the vertex Lt11 of the lens LS 11 on the upper left side of FIG. 13 (a projection position of the lens LS 11 onto the x-y plane) is used as the origin. The vertex Lt of the lens LS is a position when the height of the lens LS from the flat region Ap is a maximum value. As described above, x represents a position in the longitudinal direction LGD with the vertex Lt11 as the origin, and y represents a position in the lateral direction LTD with the vertex Lt11 as the origin. The lens surface of each lens LS is configured as follows.

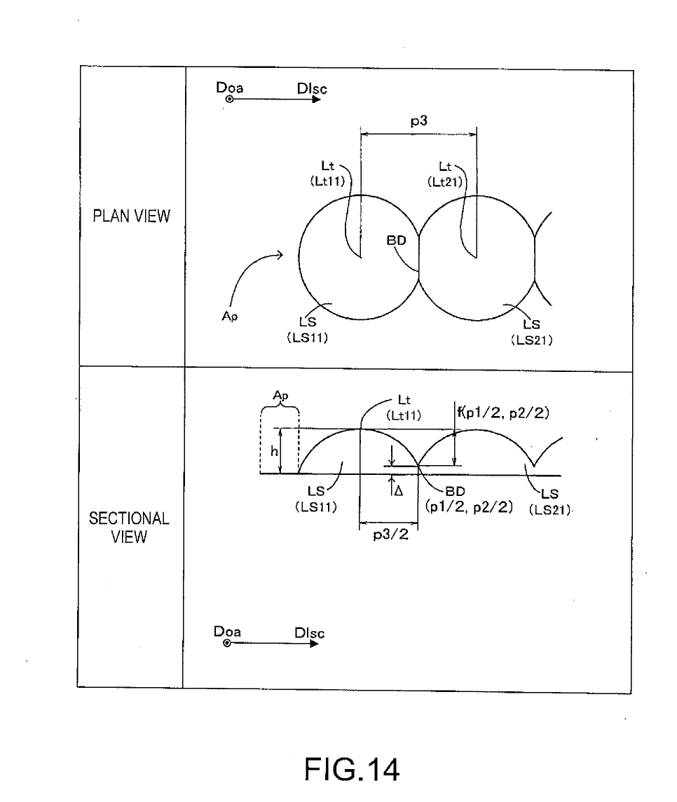

FIG. 14 is a diagram showing the configuration of the lens surface of the lens. In FIG. 14, the “PLAN VIEW” column refers to a plan view in the beam travel direction Doa, and the “SECTIONAL VIEW” column refers to a sectional view in the lens row arrangement direction Disc including the vertex Lt of the lens LS. In FIG. 14, in order to represent the relationship between two adjacent lenses LS in the lens row arrangement direction Dlsc, a lens LS11 and a lens LS21 are representatively shown. It should be noted that as occasion demands, the lens LS11 is called a “first lens”, and the lens LS21 is called a “second lens”.

The symbol h in the “SECTIONAL VIEW” column of FIG. 14 denotes a height from the flat region Ap at a position (vertex Lt) on the lens surface of each lens LS where the height from the flat region Ap has a maximum value. That is, the symbol h denotes the height of the vertex Lt of each lens LS from the flat region Ap, and each lens LS has the same height h. The function f(x,y) denotes a height from the lens surface at the position (x,y) to the vertex Lt (first position) of the lens LS. In addition, in FIG. 14, a clearance between two adjacent lenses LS in the lens row arrangement direction Dlsc is indicated by an interval p3. In this embodiment, the following equation is satisfied.

f(p1/2,p2/2)<h

That is, the first lens LS11 and the second lens LS21 are connected to each other in the lens row arrangement direction Dlsc, and the boundary ED of the first lens LS11 and the second lens LS21 has a height Δ(=h−f(p1/2,p2/2)>0) from the flat region Ap.

As described above, since adjacent lenses LS in the lens row arrangement direction Dlsc are connected to each other, the lenses LS can receive a larger amount of light without increasing the interval p3 between the lenses LS. The details are as follows.

FIG. 15 is an explanatory view of an advantage of the invention. In FIG. 15, the “UNCONNECTED” column refers to a case in which adjacent lenses LS in the lens row arrangement direction Dlsc are not connected to each other, and the “CONNECTED” column refers to a case in which adjacent lenses LS in the lens row arrangement direction Disc are connected to each other (that is, when the invention is applied). In FIG. 15, a region surrounded by a two-dot-chain line circle means an effective region LSe of the lens LS, and a solid line circle denotes an outer circumference LSc of the lens LS. In general, on the lens surface around the outer circumference LSc, surface accuracy cannot be ensured. For this reason, it is necessary to provide a margin d between the outer circumference LSc and the effective region LSe of the lens LS. As shown in the “UNCONNECTED” column, when adjacent lenses LS in the lens row arrangement direction Dlsc are not connected to each other, it is necessary to provide the margin d over the entire outer circumference LSc. In contrast, as shown in the “CONNECTED” column, if adjacent lenses LS in the lens row arrangement direction Dlsc are connected to each other, it is not necessary to provide the margin d in the lens row arrangement direction Dlsc. As a result, the lens effective region LSe can be expanded without changing the lens interval p3, and the lens LS can be adapted to receive a larger amount of light. Therefore, the lens array 299 can perform the exposure operation by a large light amount without increasing the width W2 of the lens array 299 in the lateral direction LTD, can cope with exposure with high resolution, and can be reduced in size.

With the configuration of FIG. 13, the lenses LS can be adapted to receive a large light amount without increasing the interval p3 between adjacent lenses LS in the lens row arrangement direction Dlsc. In other words, the width W2 of the lens array 299 in the lateral direction LTD can be suppressed. As a result, a region (a region in the reverse side surface of the head substrate 293) where the light emitting element group 295 is disposed to correspond to each lens LS can also be comparatively reduced in the lateral direction LTD. For this reason, in the head substrate 293 on which the light emitting element group 295 is disposed, a space can be allowed on both sides in the lateral direction LTD. In this embodiment, driving circuits DC for driving the light emitting elements 2951 of the light emitting element group 295 are provided in the empty space. The details are as follows.

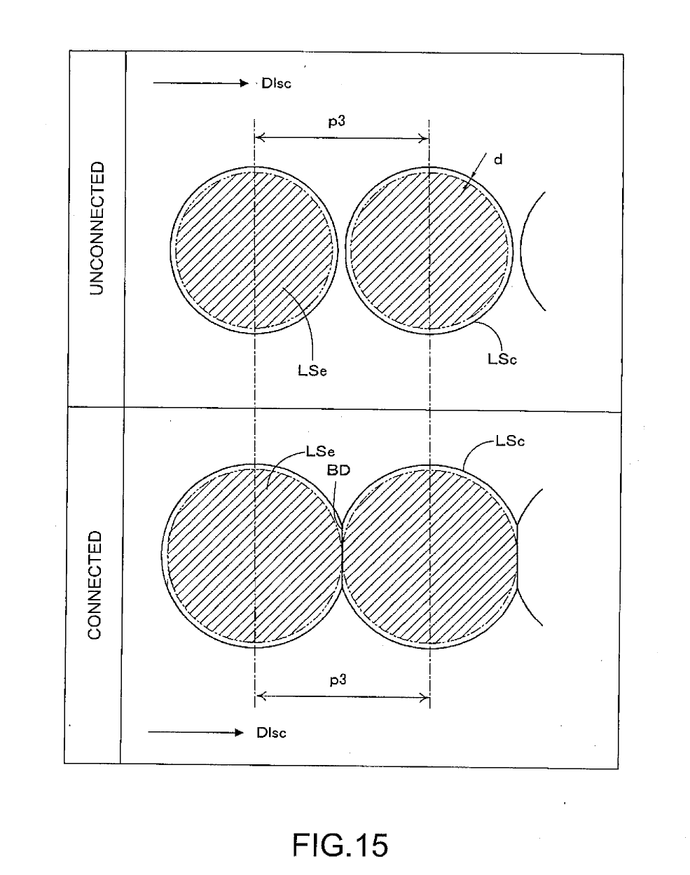

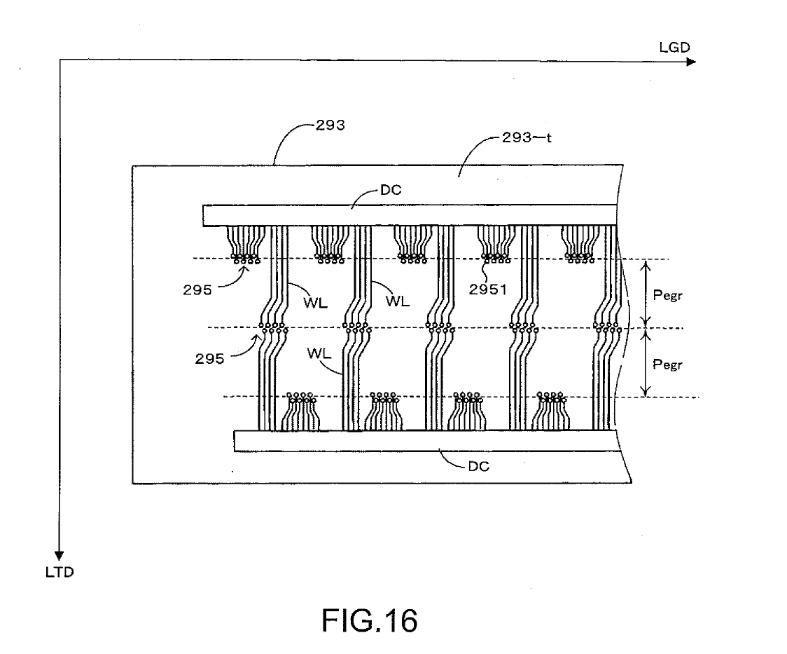

FIG. 16 is a plan view showing the configuration of the reverse side surface of the head substrate according to the second embodiment. As shown in FIG. 16, the driving circuits DC including a TFT are disposed in the empty space on both sides of the head substrate 293 in the lateral direction LTD. The driving circuits DC are connected to the light emitting element 2951 through wirings WL, and supply driving signals to the light emitting elements 2951. In this way, if the driving circuits DC are disposed in the empty space on both sides of the head substrate 293 in the lateral direction LTD, the driving circuits DC can be disposed comparatively close to the light emitting elements 2951. Therefore, the wirings WL can be reduced in length, and the driving signals having a small depression due to stray capacitance of the wirings WL can be supplied to the light emitting elements 2951. As a result, a preferable exposure operation can be performed.

In the second embodiment, the clearance CL is provided between adjacent lenses LS (for example, the lens LS11 and the lens LS12) in the longitudinal direction LGD, thereby preventing the lens array 299 from being deformed due to a change in temperature. As described above, while the lens array substrate 2991 is formed of glass, the lenses LS are formed of resin. That is, the lens array substrate 2991 and the lenses LS are formed of different materials. For this reason, when no clearance CL is provided between adjacent lenses LS in the longitudinal direction LGD, a long agglomerate in the longitudinal direction LGD is formed on the lens array substrate 299. Accordingly, if the temperature changes, the lens array 299 may be deformed due to a difference in linear expansion coefficient between the agglomerate and the lens array substrate 299. In particular, when the lenses LS are formed of resin, since the resin has a comparatively large linear expansion coefficient, this deformation may be noticeable. If the lens array 299 is deformed, the imaging position of light maybe changed, and thus a preferable exposure operation may not be performed. In contrast, in the second embodiment, since the clearance CL is provided between adjacent lenses LS (for example, the lens LS11 and the lens LS12) in the longitudinal direction LGD, the lens array 299 can be prevented from being deformed, and thus a preferable exposure operation can be performed.

In the second embodiment, the lenses LS are formed of photocurable resin. The photocurable resin is cured by light irradiation. Therefore, if the lenses LS are formed of photocurable resin, the lens array 299 can be simply manufactured.

### C. Others

In the foregoing embodiments, the longitudinal direction LGD and the main scanning direction MD correspond to the “first direction” of the invention, the lateral direction LTD and the sub scanning direction SD correspond to the “second direction” of the invention, and the photoconductor drum 21 corresponds to the “latent image carrier” of the invention. In the second embodiment, the lens LS11 and the lens LS21 provided on the lateral direction LTD side of the lens LS11 are connected to each other. The lens LS11 corresponds to the “first lens” of the invention, and the lens LS21 corresponds to the “second lens” of the invention. In addition, the clearance CL is provided between the lens LS11 and the lens LS12 provided on the longitudinal direction LGD side of the lens LS11. The lens LS12 corresponds to the “third lens” of the invention. The head substrate 293 corresponds to the “light emitting element substrate” of the invention.

The invention is not limited to the foregoing embodiments, and various modifications may be made without departing from the scope of the invention. In the foregoing embodiments, each of the light emitting element groups 295 has two light emitting element rows 2951R. However, the number of light emitting element rows 2951R constituting each of the light emitting element groups 295 is not limited to two. For example, the number of light emitting element rows 2951R may be one. In addition, in the foregoing embodiments, each of the light emitting element rows 2951R has four light emitting elements 2951. However, the number of light emitting elements 2951 constituting each of the light emitting element rows 2951R is not limited to four. Therefore, each of the light emitting element groups 295 can be constituted as follows.

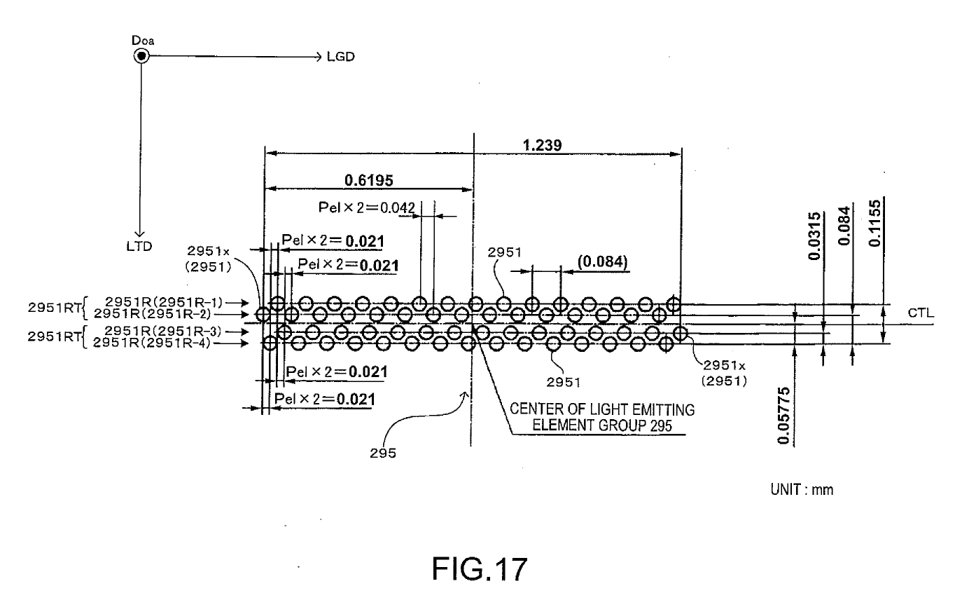

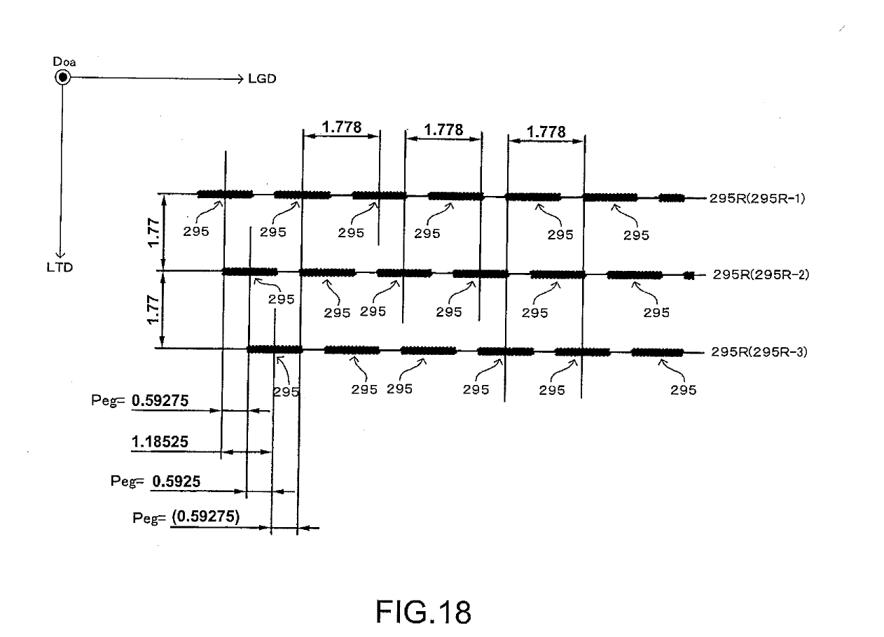

FIG. 17 is a plan view showing another example of the configuration of the light emitting element group. FIG. 18 is a diagram showing the reverse side surface of the head substrate on which a plurality of light emitting element groups of FIG. 17 are arranged, and corresponds to a case in which the reverse side surface is viewed from the surface of the head substrate. In another configuration shown in FIG. 18, 15 light emitting elements 2951 are arranged in the longitudinal direction LGD to form each of the light emitting element rows 2951R. In each of the light emitting element rows 2951R, the light emitting elements 2951 are arranged at a pitch (=0.084 [mm]) four times larger than the element pitch Pel (=0.021 [mm]). Four light emitting element rows 2951R (2951R-1, 2951R-2, 2951R-3, and 2951R-4) having the above-described configuration are arranged in the lateral direction LTD. In the lateral direction LTD, the pitch between the light emitting element row 2951R-4 and the light emitting element row 2951R-1 is 0.1155 [mm] the pitch between the light emitting element row 2951R-4 and the light emitting element row 2951R-2 is 0.084 [mm], and the pitch between the light emitting element row 2951R-4 and the light emitting element row 2951R-3 is 0.0315 [mm]. Let a line parallel to the lateral direction LTD passing through the center (gravity center) of each of the light emitting element group 295 be a center line CTL, the pitch between the light emitting element rows 2951R-1 and 2951R-4 and the center line CTL is 0.05775 [mm].

In FIG. 17, two rows 2951R-1 and 2951R-2 above the center line CTL form a set of light emitting element rows 2951RT, and two rows 2951R-3 and 2951R-4 below the center line CTL form a set of light emitting element rows 2951RT. In each set of light emitting element rows 2951RT, two light emitting element rows 2951R are out of alignment in the longitudinal direction LGD by a pitch (=0.042 [mm]) two times larger than the element pitch Pel (=0.021 [mm]). In addition, the two sets of light emitting element rows 2951RT are out of alignment in the longitudinal direction LGD by the element pitch Pel (=0.021 [mm]). Therefore, the four light emitting element rows 2951R are out of alignment in the longitudinal direction LGD by the element pitch Pel (=0.021 [mm]). As a result, the positions of the light emitting elements 2951 in the longitudinal direction LGD are different from each other. Here, let the light emitting elements 2951 located at both ends of each of the light emitting element groups 295 in the longitudinal direction LGD be end portion light emitting elements 2951x, the pitch between the end portion light emitting elements 2951x in the longitudinal direction LGD is 1.239 [mm], and the pitch between each end portion light emitting element 2951x and the center of the light emitting element group 295 in the longitudinal direction LGD becomes 0.6195 [mm].

In the example of FIG. 18, the light emitting element groups 295 shown in FIG. 17 are disposed in a two dimensional manner. As shown in FIG. 1B, a plurality of light emitting element groups 295 are arranged in the longitudinal direction LGD to form each of the light emitting element group rows 295R. In each of the light emitting element group rows 295R, the light emitting element groups 295 are arranged by a pitch (=1.778 [mm]) three times larger than the light emitting element group pitch Peg. Three light emitting element group rows 295R (295R-1, 295R-2, and 295R-3) having the above-described configuration are arranged in the lateral direction LTD by the light emitting element group row pitch Pegr (=1.77 [mm]). In addition, the light emitting element group rows 295R are out of alignment in the longitudinal direction LGD by the light emitting element group pitch Peg (about 0.593 [mm]). That is, the light emitting element group row 295R-1 and the light emitting element group row 295R-2 are out of alignment in the longitudinal direction LGD by 0.59275 [mm], the light emitting element group row 295R-2 and the light emitting element group row 295R-3 are out of alignment in the longitudinal direction LGD by 0.5925 [mm], and the light emitting element group row 295R-3 and the light emitting element group row 295R-1 are out of alignment in the longitudinal direction LGD by 0.59275 [mm]. Therefore, the light emitting element group row 295R-1 and the light emitting element group row 295R-3 are out of alignment in the longitudinal direction LGD by 1.18525 [mm].

In the foregoing embodiments, the lens array 299 is formed by forming the lenses LS on the reverse side surface 2991-t of the lens array substrate. However, the configuration of the lens array is not limited thereto. For example, the lens array 299 may be formed by forming the lenses LS on the surface 2991-h of the lens array substrate, or the lens array 299 may be formed by forming the lenses LS on both surfaces 2991-t and 2991-h of the lens array substrate.

In the foregoing embodiment, the three lens rows LSR are arranged in the lateral direction LTD. However, the number of lens rows LSR is not limited to three. For example, the number of lens rows LSR may be one.

In the foregoing embodiments, the two lens arrays 299 are used, but the number of lens arrays 299 is not limited thereto.

In the foregoing embodiment, an organic EL element is used as the light emitting element 2951. However, an element other than the organic EL element may be used as the light emitting element 2951, or an LED (Light Emitting Diode) may be used as the light emitting element 2951.

### EXAMPLE

Next, an example of the invention will be described. It should be noted that the invention is not limited to the example, and various modifications, which also fall within the technical scope of the invention, may be made without departing from the scope of the invention.

The following example refers to the configuration capable of reducing the size of the image forming apparatus and achieving preferable exposure. Specifically, the diameter of the photoconductor drum 21 becomes a factor in determining the size of the image forming apparatus. For this reason, in terms of reduction of the size of the image forming apparatus, it is demanded to reduce the diameter of the photoconductor drum 21. Meanwhile, around the photoconductor drum 21, the functional sections, such as the charging section 23, the developing section 25, and the like, need to be disposed in the sub scanning direction SD, in addition to the line head 29. Therefore, if the photoconductor drum 21 is simply reduced in diameter, these functional sections may not be disposed. In contrast, as described in the foregoing embodiments, the line head 29 of the invention becomes small in size in the lateral direction LTD (sub scanning direction SD). Therefore, a space for the functional sections can be ensured, and the photoconductor drum 21 can be reduced in diameter.

When the photoconductor drum 21 is reduced in diameter, the following problems may occur. That is, when the photoconductor drum 21 is reduced in diameter, the curvature of the surface shape of the photoconductor drum 21 increases. For this reason, like the above-described line head 29, when a plurality of lenses LS are provided in the lateral direction LTD, if the imaging position of each lens LS in the beam travel direction Doa is set so as to be identical, there may be a lens LS in which the imaging position is out of alignment with the surface of the photoconductor drum 21. As a result, preferable exposure may not be performed. In the following example, a technology capable of reducing the diameter of the photoconductor drum 21 and achieving preferable exposure will be described.

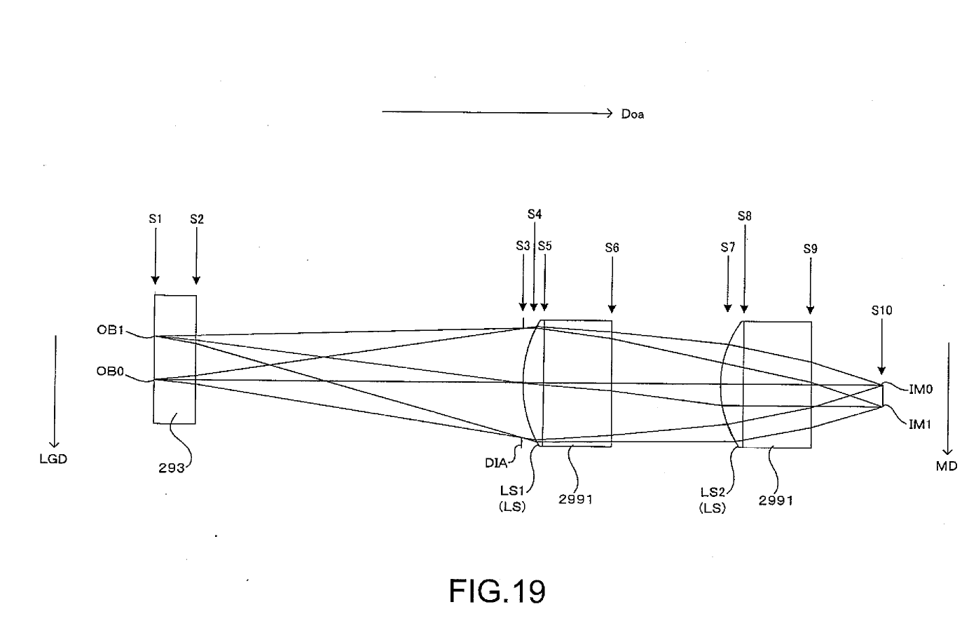

FIG. 19 is a diagram showing an optical system according to an example, and shows a section in the main scanning direction MD. In this example, a diaphragm DIA is provided in front of a first lens LS1 in the beam travel direction Doa, and a light beam focused by the diaphragm DIA is incident on the first lens LS1. FIG. 19 shows an optical path of a light beam which is emitted from an object point OB0 on the optical axis OA and imaged at an image point IM0, and an optical path of a light beam which is emitted from another object point OB1 on the optical axis OA and imaged at an image point IM1. The configuration other than the diaphragm DIA is substantially the same as that shown in the first embodiment or the like. Optical systems including lenses LS are arranged such that three lenses LS-u, LS-m, and LS-d are arranged in a direction along the line A-A of FIG. 5 or the line A-A of FIG. 9 to form each of the lens columns.

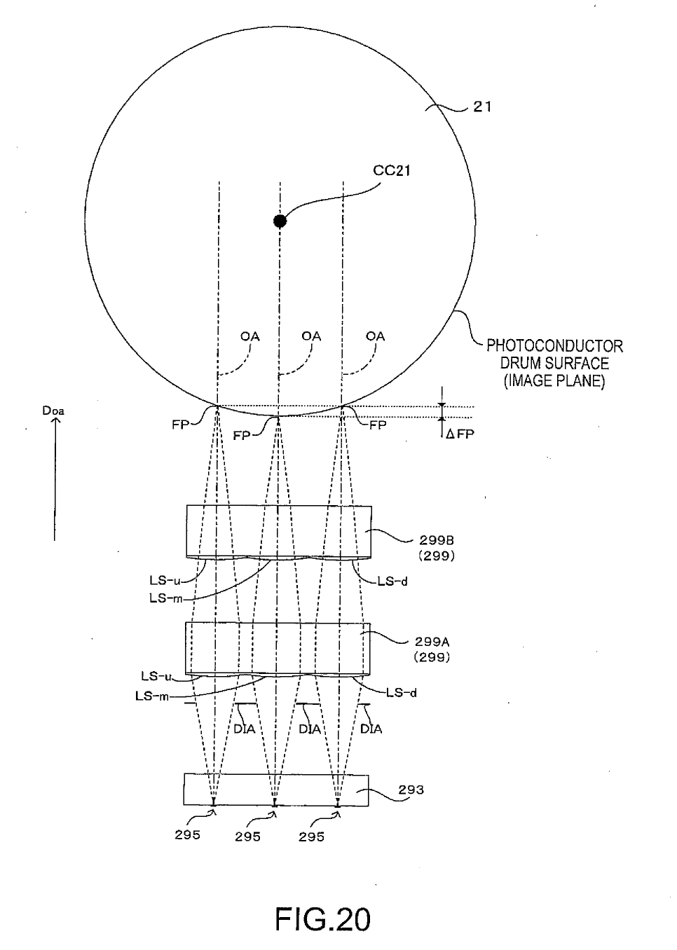

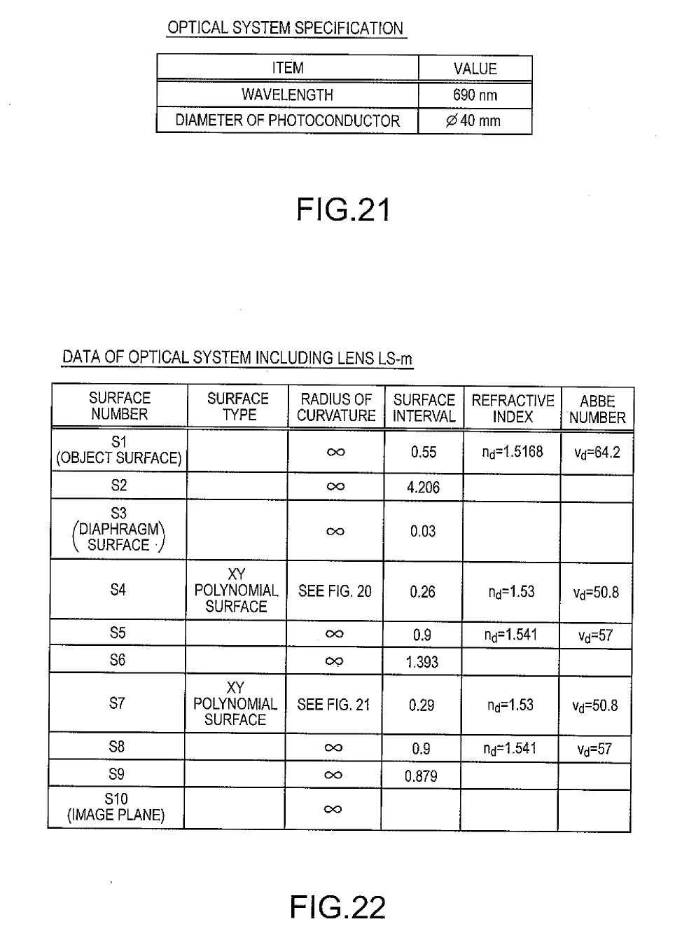

FIG. 20 is a sectional view of the line head and the photoconductor drum along the line A-A in the example. As shown in FIG. 20 the line head including the light emitting element groups 295, the diaphragm DIA, and the lens arrays 299A and 299B is disposed so as to be opposite to the photoconductor drum 21. The photoconductor drum 21 has a substantially cylindrical shape around a rotation axis CC21 as a center, and the surface of photoconductor drum has a finite curvature. It is assumed that the shape of the photoconductor surface is specifically called a “curvature shaper”.

In this example, the optical systems are arranged in the left-right direction of FIG. 20 at the same pitch, and the optical axis OA of an optical system including the middle lens LS-m passes through the rotation axis CC21 of the photoconductor drum 21. For this reason, in order to match the imaging position of the light beam by each optical system with the surface of the photoconductor drum, it is necessary to adjust the imaging position in the beam travel direction Doa (an optical axis OA direction) for each optical system. In the example of FIG. 20, the imaging position FP in the beam travel direction Doa is identical between the optical system including the upstream lens LS-u and the optical system including the downstream lens LS-d. Meanwhile, the imaging position FP in the beam travel direction Doa varies between the optical system including the upstream lens LS-u (or the downstream lens LS-d) and the optical system including the middle lens LS-m by a distance ΔFP. As shown in data described below, in this example, the optical systems including the lenses LS-u and LS-d and the optical system including the lens LS-m have different configuration.

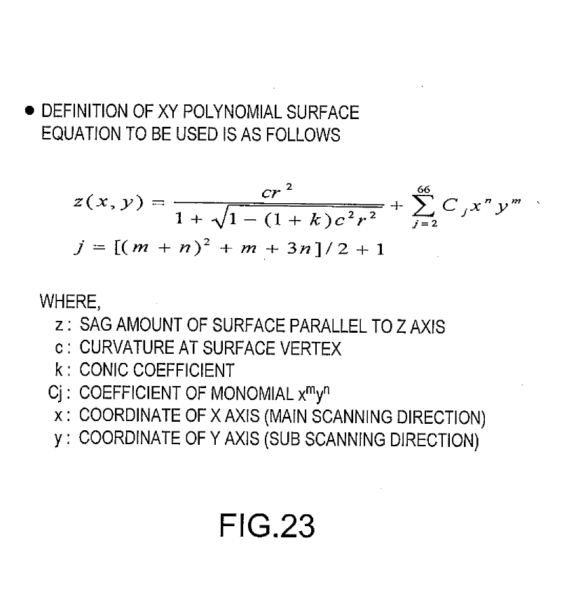

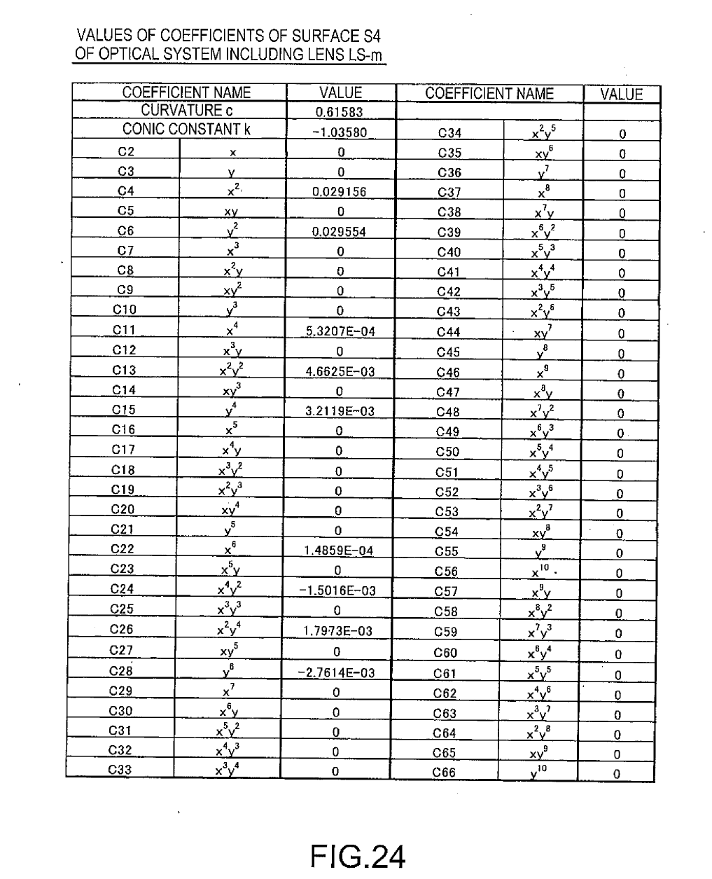

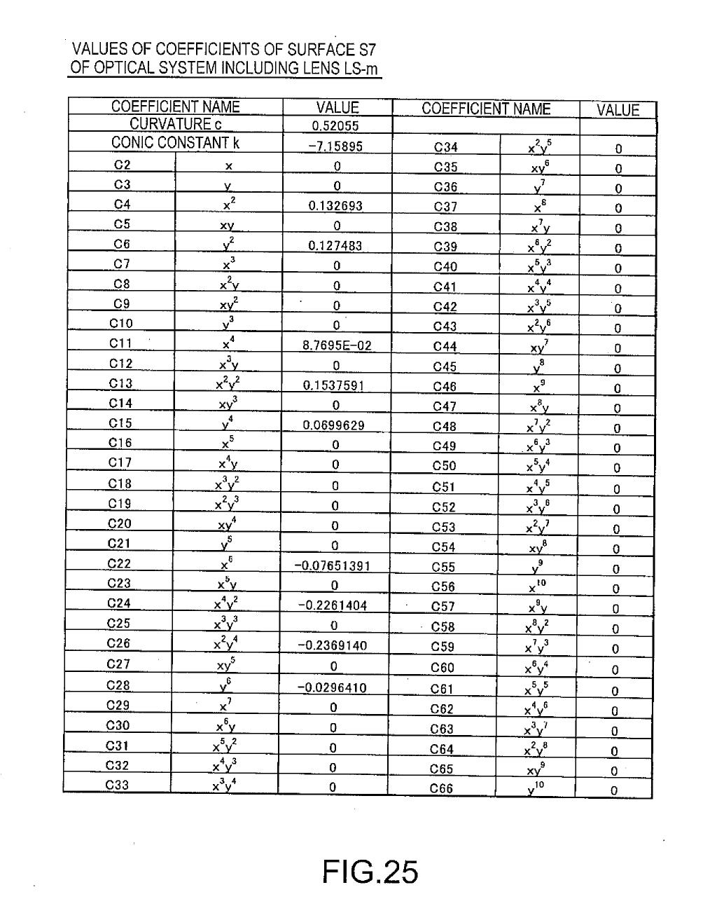

FIG. 21 is a diagram showing an optical system specification in an example. As shown in FIG. 21, the wavelength of a light beam emitted from the light emitting element is 690 [nm]. The diameter of the photoconductor is 40 [mm]. FIG. 22 is a diagram showing data of the optical system including the middle lens. As shown in FIG. 22, in the optical system including the middle lens LS-m, the lens surface (surface number S4) of the first lens LS1 and the lens surface (surface number S7) of the second lens LS2 are free-form surfaces (XY polynomial surface). FIG. 23 is a diagram showing a definitional equation of the XY polynomial surface. The lens surface shape of the first lens LS1 is given by the definitional equation and coefficients shown in FIG. 24, and the lens surface shape of the second lens LS2 is given by the definitional equation and coefficients shown in FIG. 25. FIG. 24 is a diagram showing the values of coefficients of the surface S4 of the optical system including the middle lens. FIG. 25 is a diagram showing the values of coefficients of the surface S7 of the optical system including the middle lens.

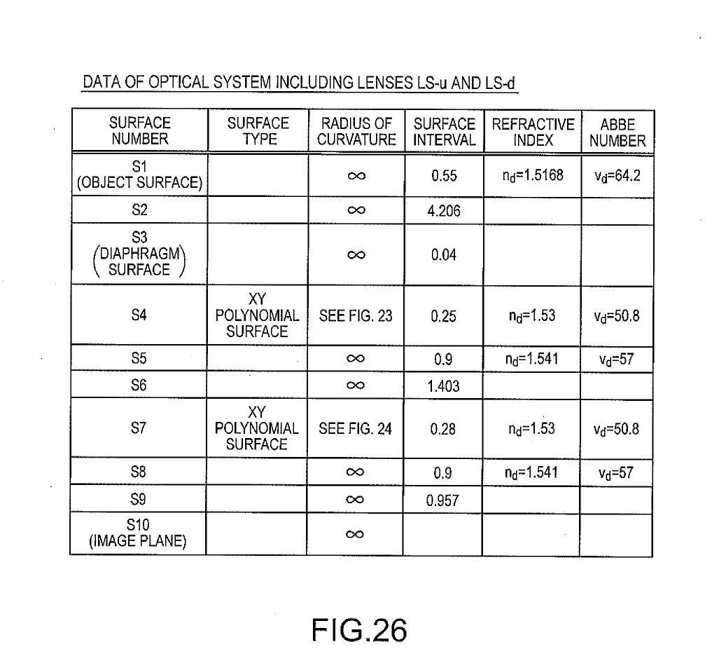

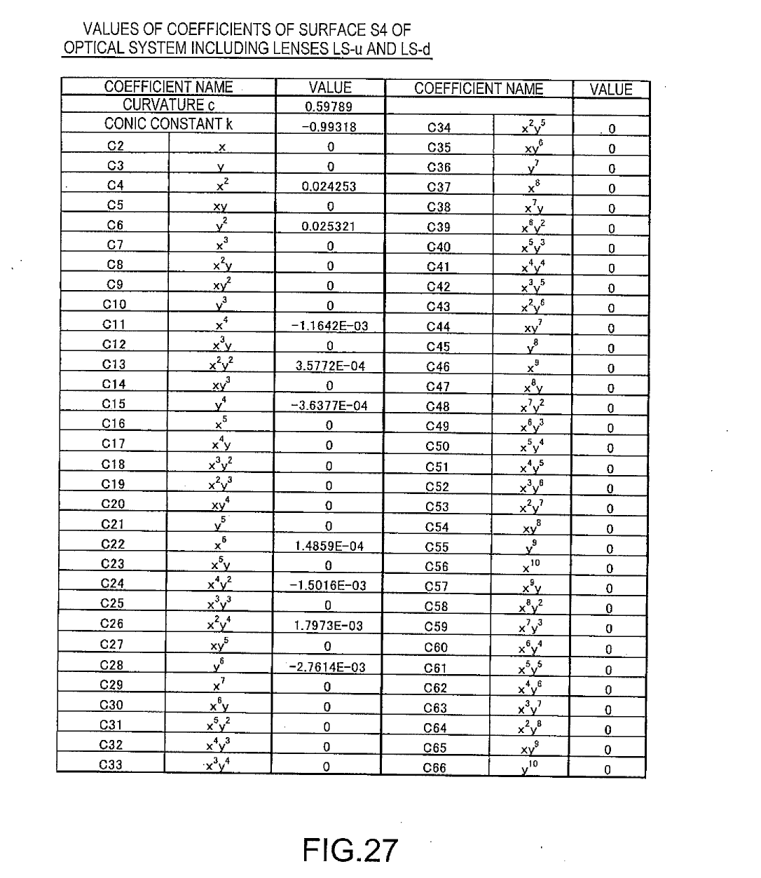

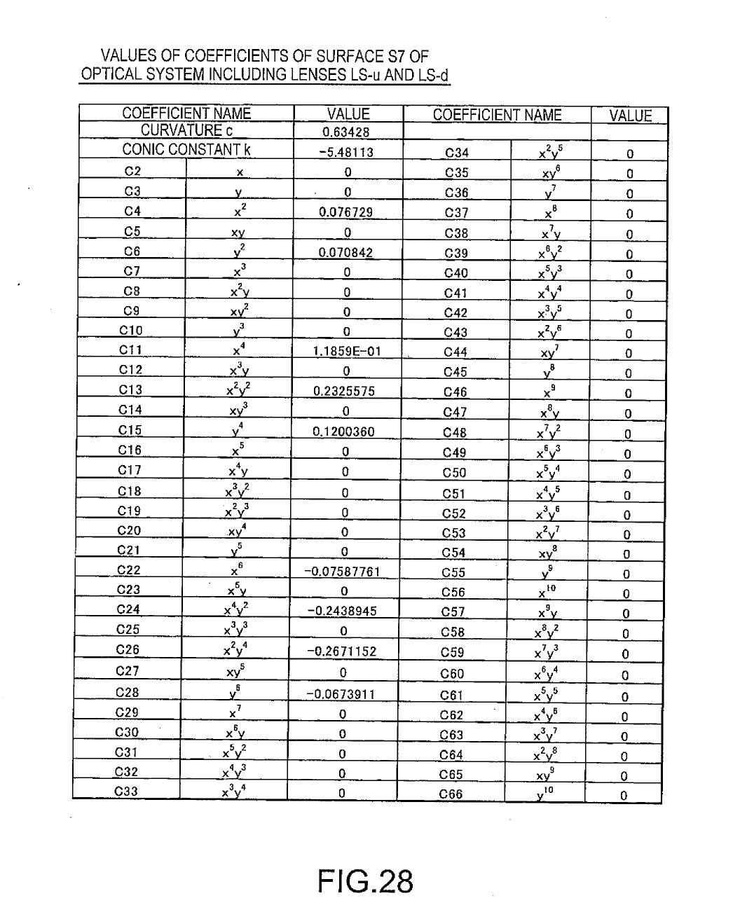

FIG. 26 is a diagram showing data of the optical system including the upstream lens and the downstream lens. As shown in FIG. 26, in the optical system including the upstream lens LS-u and the downstream lens LS-d, the lens surface (surface number S4) of the first lens LS1 and the lens surface (surface number S7) of the second lens LS2 are also free-form surfaces (XY polynomial surface). The lens surface shape of the first lens LS1 is given by the definitional equation of FIG. 23 and coefficients shown in FIG. 27, and the lens surface shape of the second lens LS2 is given by the definitional equation and coefficients shown in FIG. 28. FIG. 27 is a diagram showing the values of coefficients of the surface S4 of the optical system including the upstream lens and the downstream lens. FIG. 28 is a diagram showing the values of coefficients of the surface S7 of the optical system including the upstream lens and the downstream lens.

In this way, the imaging position of each of the lenses LS is adjusted in accordance with the surface shape of the photoconductor drum 21. Therefore, the photoconductor drum 21 is reduced in diameter, thereby reducing the size of the image forming apparatus, and thus preferable exposure can be achieved.

In the foregoing example, the lenses LS of the lens array 299 are free-form surface lenses. The free-form surface lens is a lens whose lens surface is a free-form surface. Therefore, the imaging characteristics of the lenses can be improved, and thus preferable exposure can be achieved.

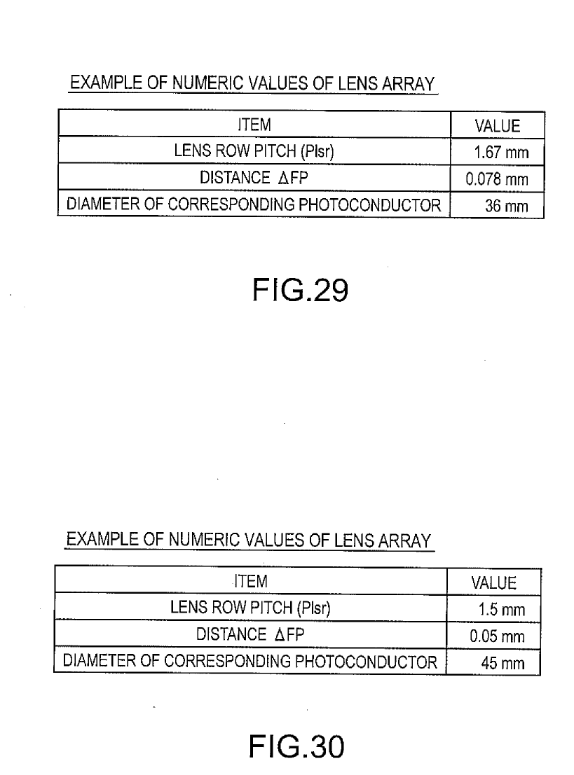

The diameter of the photoconductor drum 21 is not limited to the above-described value, but it may be changed. For example, as shown in FIG. 29, the diameter of the photoconductor drum 21 may be changed. FIG. 29 is a diagram showing another example of numerical values, and corresponds to a case in which the diameter of the photoconductor drum 21 is 36 [mm]. If the invention is applied, and the lenses LS arranged in the lens row arrangement direction Dlsc (in other words, the lenses LS disposed at different positions in the lateral direction LTD) are connected to each other, as shown in FIG. 29, the lens row pitch Plsr is suppressed to 1.67 [mm].

In addition, in order to adjust the imaging position FP for each lens LS in accordance with the shape of the photoconductor drum 21 having a diameter of 36 [mm], the imaging position varies between the optical system including the upstream lens LS-u (or the downstream lens LS-d) and the optical system including the middle lens LS-m. Specifically, the distance ΔFP is set to 0.078 [mm]. In another example of the numerical values, the distance ΔFP is obtained on the basis of data of the optical systems shown in FIGS. 21 to 28.

FIG. 30 is a diagram showing yet another example of numerical values, and corresponds to a case in which the diameter of the photoconductor drum 21 is 45 [mm]. In this example of the numerical values, the lens row pitch Plsr is suppressed to 1.5 [mm]. In addition, in order to adjust the imaging position FP for each lens row LSR in accordance with the shape of the photoconductor drum 21 having a diameter of 45 [mm], the imaging position varies between the optical system including the upstream lens LS-u (or the downstream lens LS-d) and the optical system including the middle lens LS-m. Specifically, the distance ΔFP is set to 0.05 [mm].

As described above, in yet another example of the numerical values, the distance ΔFP is suppressed small, as compared with another example of the numerical values described above. As a result, lens design can be simplified without significantly changing the lens characteristic of each lens LS so much. This is because the lens row pitch Plsr (=1.5 [mm]) is set so as to be smaller than the diameter (=45 [mm]) of the photoconductor drum 21. What is necessary to simplify lens design is that the lens row pitch Plsr is equal to or less than ½ of the diameter (=45 [mm]) of the photoconductor drum 21. In this example, the lens row pitch Plsr corresponds to the “clearance between the first lens and the second lens in the second direction” of the invention.

What is claimed is:

1. A lens array comprising:
a light-transmissive substrate that satisfies the condition W1>W2, where W1 is the length of the light-transmissive substrate in a first direction and W2 is the length of the light-transmissive substrate in a second direction perpendicular to the first direction;
a first lens that is provided on the light-transmissive substrate; and
a second lens that is provided on the light-transmissive substrate on the second direction side of the first lens,
wherein the first lens and the second lens are connected to each other.

2. The lens array according to claim 1,
wherein the light-transmissive substrate is provided with a third lens on the first direction side of the first lens, and a clearance is provided between the first lens and the third lens.

3. The lens array according to claim 2,
wherein the light-transmissive substrate is a glass member.

4. The lens array according to claim 3,
wherein the first lens, the second lens, and the third lens are formed of a resin material.

5. The lens array according to claim 4,
wherein the resin material is photocurable resin.

6. An exposure head comprising:
a lens array that has a light-transmissive substrate satisfying the condition W1>W2, where W1 is the length of the light-transmissive substrate in a first direction and W2 is the length of the light-transmissive substrate in a second direction perpendicular to the first direction, a first lens provided on the light-transmissive substrate, and a second lens provided on the light-transmissive substrate on the second direction side of the first lens; and
a light emitting element substrate that has a first light emitting element emitting light toward the first lens, and a second light emitting element emitting light toward the second lens,
wherein the first lens and the second lens are connected to each other.

7. The exposure head according to claim 6,
wherein the light emitting element substrate is provided with driving circuits for driving the first light emitting element and the second light emitting element on the second direction side of the first light emitting element and the second light emitting element.

8. The exposure head according to claim 7,
wherein the light emitting element substrate is provided with a first wiring connecting the first light emitting element and the driving circuit, and a second wiring connecting the second light emitting element and the driving circuit.

9. The exposure head according to claim 7,
wherein the driving circuit includes a TFT.

10. The exposure head according to claim 6,
wherein the first light emitting element and the second light emitting element are organic EL elements.

11. The exposure head according to claim 10,
wherein the organic EL elements are a bottom emission type.

12. An image forming apparatus comprising:
an exposure head that has a lens array having a light-transmissive substrate satisfying the condition W1>W2, where W1 is the length of the light-transmissive substrate in a first direction and W2 is the length of the light-transmissive substrate in a second direction perpendicular to the first direction, a first lens provided on the light-transmissive substrate, and a second direction provided on the light-transmissive substrate on the second lens side of the first lens, and a light emitting element substrate having a first light emitting element emitting light toward the first lens and a second light emitting element emitting light toward the second lens; and
a latent image carrier on which light incident on the first lens from the first light emitting element is imaged, and light incident on the second lens from the second light emitting element is imaged,
wherein the first lens and the second lens are connected to each other.

13. The image forming apparatus according to claim 12,
wherein the latent image carrier is a photoconductor drum, and an imaging position of light having entered and been imaged on the first lens and an imaging position of light having entered and been imaged on the second lens are adjusted in accordance with the shape of the photoconductor drum.

14. The image forming apparatus according to claim 13,
wherein a clearance between the first lens and the second lens in the second direction is smaller than 1/20 of the diameter of the photoconductor drum.

15. The image forming apparatus according to claim 13,
wherein the first lens and the second lens are free-form surface lenses.
